(19) United States
(12) Patent Application Publication
(10) Pub. No.: US 2013/0188464 A1
(43) Pub. Date: Jul. 25, 2013

(54) RECORD/ACCESS DEVICE AND RECORD/ACCESS METHOD

(71) Applicants: Yoshihisa Takahashi, Osaka (JP); Hisae Kato, Osaka (JP); Motoshi Ito, Osaka (JP)

(72) Inventors: Yoshihisa Takahashi, Osaka (JP); Hisae Kato, Osaka (JP); Motoshi Ito, Osaka (JP)

(73) Assignee: PANASONIC CORPORATION, Osaka (JP)

(21) Appl. No.: 13/877,392

(22) PCT Filed: Feb. 7, 2012
(86) PCT No.: PCT/JP2012/000798

§ 371 Date: Apr. 2, 2013

(30) Foreign Application Priority Data
Feb. 8, 2011 (JP) 2011-024917

(51) Int. Cl. G11B 20/18

(52) U.S. Cl. CPC G11B 20/18
USPC 369/53.15; 369/53.35

(57) ABSTRACT

A recording/reproduction device according to the present invention includes a recording/reproduction section for recording or reproducing data on or from an information recording medium; a verification section for checking whether or not the data recorded on the information recording medium can be reproduced normally; a management information recording section for recording, on the information recording medium by use of the recording/reproduction section, only management information which needs to be changed among a plurality of types of management information for managing the data recorded on the information recording medium; and a management information checking section for checking, by use of the verification section, whether or not latest management information including management information which does not need to be changed and is to be reused can be reproduced normally.

### TECHNICAL FIELD

The present invention relates to a recording/reproduction device and a recording/reproduction method for performing recording and reproduction on and from an information recording medium having management information for managing user data recorded thereon.

### BACKGROUND ART

Along with the recent spread of personal computers, the amount of data stored on a storage device such as a hard disc or the like is rapidly increasing. The Financial Instruments and Exchange Act and the New Corporation Law impose a duty of internal control. In addition, as the capacity of the storage device is increased, the amount data which can be lost by malfunction is also increased. For these reasons, the importance of data protection is enhanced. For data protection, it is known to construct a RAID (Redundant Array of Inexpensive Disks) by use of a plurality of storage devices. RAID is a technology of guaranteeing redundancy. For RAID, a plurality of levels are defined by the difference of mechanism, examples of which will be described below. According to RAID1, the same data is recorded on a plurality of storage devices, so that the data is not lost even if one storage device malfunctions. According to RAID5, parity data is generated from the recorded data and recorded in a dispersed manner, so that even if one storage device malfunctions, data can be restored from the data stored on the other storage devices. According to RAID6, two types of parity data are generated and recorded in a dispersed manner, so that even if two storage devices malfunction, data can be restored from the data stored on the other storage devices. For constructing a RAID, an appropriate level is selected in accordance with the reliability required of the data to be stored. In order to improve the reliability, a plurality of levels, for example, RAID1 and RAID5, may be used in combination.

As a storage device for storing such data, a hard disc is generally. used. Along with the recent increase of the data amount to be stored, there occurs a problem that the amount of power consumed by hard discs is increased. Hence, a storage device capable of storing data with a smaller amount of power is desired. As a storage device capable of storing data with a smaller amount of power than a hard disc, a storage device using an optical disc is now a target of attention.

Data is recorded on an optical disc in the state where a strong error correction code is attached to data on a basis of a prescribed unit for the purpose of data protection. This arrangement is provided so that even if an error occurs to the reproduction data due to, for example, a scratch or dust on a surface of the disc, poor recording quality or time degradation, the data can be reproduced correctly.

A DVD-RAM, which is a rewritable DVD and Blu-ray discs (hereinafter, referred to simply as “BDs”) including a BD-RE, which is a rewritable disc and a BD-R, which is a write-once read-many disc support a defect management function for data protection. The defect management function is a technology by which, when a defect is detected during recording of data (i.e., when data cannot be recorded correctly), the data is recorded in another area such as a spare area prepared for replacement recording so that the recorded data can be reproduced correctly.

Data recordable on an optical disc includes user data and also management information for managing the user data. Such management information may be defect management information for managing a defect, recording management information for managing a structure or a recording state of the optical disc, a file management information for managing the position of the recorded user data, or the like. Thus, in order to reproduce the user data correctly from the optical disc, it is indispensable to reproduce such management information correctly. Namely, in order protect data by a storage device using an optical disc, the management information, as well as the user data, needs to be protected.

For recording the management information, like for recording usual data, an error correction code is attached to data on a basis of a prescribed unit. Therefore, the data is protected by the error correction. However, the replacement recording performed by the above-described defect management is applicable to recording of user data, but is not applicable to the management information for defect management (i.e., defect management information).

Thus, the following method is disclosed: after the management information is recorded, verification is performed to check whether or not the data has been recorded correctly; and when a defect is detected, the data is recorded in a subsequent unrecorded area (see Patent Document 1). According to this method, the verification is performed after the management information is recorded. Therefore, it can be checked whether or not the recorded management information can be reproduced correctly. Even if a defect occurs at the time of recording the management information, the data is recorded in an area with no defect. Thus, the data can be recorded correctly.

However, a defect is not the only error which may occur at the time of recording on an optical disc.

An optical disc has a track (guide groove). Recording and reproduction are performed while laser light follows the track (tracking). For example, the laser light may derailed from the track and jumps to another track due to an external impact caused by collision or a scratch or dust on a surface of the disc. When such an error occurs during recording, data in the another track is destroyed. In this case, the data to be recorded can be re-recorded correctly by retry, but the destroyed data cannot be restored and is lost.

Thus, the following method is disclosed: when a recording error occurs, data is read from an adjacent area; and when an error is detected in read data, the data is restored from the adjacent area by use of a RAID function (see Patent Document 2).

The following method is also disclosed: before starting the recording, data is reproduced from a prescribed range of several tracks before and after the recording start position, and the data is reproduced again from the prescribed range after the recording and is compared with the data reproduced before the recording, so that it is determined whether or not the recording has been performed correctly (Patent Document 3).

### CITATION LIST

### Patent Literature

Document 1: International Publication WO2006/075707
Patent Document 2: Japanese Laid-Open Patent Publication No. 2007-280226
Patent Document 3: Japanese Laid-Open Patent Publication No. 2007-102851

### SUMMARY OF INVENTION

### Technical Problem

However, the above-described method of restoring the data from the adjacent area by use of the RAID function has a problem that only the user data can be restored by use of the RAID function, but the management information cannot be restored.

The above-described method of comparing the data in the prescribed range reproduced before and after the recording has a problem that when the data outside the prescribed range is destroyed, the data cannot be protected. If the prescribed range is expanded in order to broaden the area where the data can be protected, there occurs a problem that the memory capacity for storing the reproduced data needs to be increased and thus the cost is raised. There is another problem that the reproduction time is extended and thus the processing rate is decreased.

FIG. 13 shows an example of management information which is recorded in a TDMA (Temporary Disc Management Area) of a BD-R, which is a management information area where management information is to be recorded. Since the BD-R is a write-once read-many optical disc, data cannot be rewritten. Therefore, the management information is also updated by performing write-once recording sequentially. Namely, latest management information is recorded at a trailing end position of a recorded area in the TDMA (border with a non-recorded area).

In the TDMA, a TDMS (Temporary Disc Management Structure), which is a management information structure, is recorded. The TDMS is basically formed of a plurality of types of management information. Specifically, the TDMS is formed of a TDFL (Temporary Defect List), which is defect management information, recording management information, which is management information regarding a recording state, and a TDDS (Temporary Disc Definition Structure), which includes information regarding a position at which management information included in the TDMS is recorded, an area structure of the disc and the like. The recording management information is classified into two types, i.e., an SRRI (Sequential Recording Range Information) and an SBM (Space Bit Map). During sequential mode recording in which recording is continuously performed in an area subsequent to a certain write-once position, the SRRI is recorded. During random recording mode in which recording is performed at any unrecorded area, the SBM is recorded. The management information shown in FIG. 13 is recorded in the TDMA during sequential mode recording.

FIG. 13(a) shows a state before TDMS Update Unit #3 is recorded, and FIG. 13(b) shows a state after TDMS Update Unit #3 is recorded. In FIG. 13(a) and FIG. 13(b), a top end of the figure is the leading end of the TDMA area, and clusters of the TDMA are sequentially arranged toward a bottom end of the figure.

A “cluster” is a unit by which an error correction code is given, and is a minimum unit by which data can be recorded on an optical disc.

A “TDMS Update Unit” is a unit by which the management information is updated. As described above, a BD-R is a write-once read-many optical disc, and thus data can be recorded only once at the same position. Therefore, when recording management information in the TDMA, the management information is recorded in subsequent clusters and thus the TDMA is consumed. When the TDMA is used up, data cannot be managed and thus the user data cannot be recorded. For this reason, when recording management information in the TDMA, the management which has been recorded previously and has not been changed is reused. The recording is performed on a basis of a TDMS Update Unit formed of only the management information which needs to be recorded in an updated manner. By recording only the management information which needs to be recorded in an updated manner, the consumption of the TDMA is suppressed.

In order to acquire the latest TDMS quickly, the latest TDDS having the information on the position of the management information is necessarily located in a final sector of the cluster of the TDMS Update Unit recorded in the TDMA. Therefore, in FIG. 13(a), TDDS #2 recorded in cluster #5 is the latest TDDS. The latest TDDS includes pointers indicating positions at which the latest SRRI and the latest TDFL are recorded. In FIG. 13(a), SRRI #1 recorded in cluster #1 is the latest SRRI. First TDFL #1, second TDFL #1 and third TDFL #1 respectively recorded in cluster #2, cluster #4 and cluster #5 are the latest TDFLs. Second TDFL #1 was attempted to be recorded in cluster #3 but the recording failed (cluster #3 is regarded as a defective cluster), and thus is recorded in the next cluster #4.

In the state shown in FIG. 13(b), only the SRRI has been changed from the state in FIG. 13(a). Therefore, the SRRI is recorded as TDMS Update #3 together with the latest TDDS. In FIG. 13(b), first TDFL #1 recorded in cluster #2, second TDFL #1 recorded in cluster #4, third TDFL #1 recorded in cluster #5, and SRRI #2 and TDDS #3 recorded in cluster #6 are the latest management information.

As described above, in a BD-R, all the latest management information is not recorded in continuous areas. Namely, if the method, described in Patent Document 3, comparing the data reproduced from a prescribed range before and after the recording is used when the management information is recorded, there occurs a problem that management information which does not need to be reproduced, for example, SRRI #1 or TDDS #1 shown in FIG. 13(b), is reproduced and compared. There is another problem that, when a defect is detected in the prescribed range as cluster #3 in FIG. 13, data in a defective area in which data cannot be reproduced is attempted to be reproduced, and a long time is used for such an unnecessary reproduction process.

In Patent Document 1, after the management information is recorded, verification is performed. According to this method, when TDMS Update Unit #3 in FIG. 13(b) is recorded, verification is performed only on cluster #6 in which TDMS Update Unit #3 is recorded in the current operation. When TDMS Update Unit #3 is recorded, the verification is performed on none of cluster #2, cluster #4 and cluster #5 in which first TDFL #1, second TDFL #1 and third TDFL #1 was recorded previously, because verification was performed previously when these TDFLs were recorded. Now, a case will be discussed where, for example, during the recording of TDMS Update Unit #3, track jump occurs and data in cluster #2, cluster #4 and cluster #5 is destroyed. In this case, verification performed merely on cluster #6 cannot detect that first TDFL #1, second TDFL #1 and third TDFL #1 as the latest management information cannot be reproduced. As a result, a problem occurs that when the disc is re-mounted later, the management information cannot be acquired successfully and the user data cannot be reproduced. Similarly, in the case where a scratch is made on, or dust is attached to, the surface of the disc after data is recorded in cluster #2, cluster #4 and cluster #5, verification performed merely on cluster #6 cannot detect that first TDFL #1, second TDFL #1 and third TDFL #1 cannot be reproduced. As a result, a problem occurs that the user data cannot be reproduced.

There is also a problem that since it is now made more difficult to follow the track by an increase of capacity of an optical disc, the possibility that data in the track in the vicinity of the track to be followed is destroyed is raised and the influence of the destruction is increased.

According to an example of method for increasing the capacity of an optical disc, the spot diameter of laser light is decreased by use of an SIL (Solid Immersion Lens) adopting a minute lens having a high refractive index or by use of close field light. Thus, the length of the recording mark or the width of the track is decreased, and the recording density per recording layer is raised. According to another method, a plurality of recording layers are stacked.

When the width of the track is decreased in order to raise the recording density, unintentional track jump easily occurs, and the possibility that an adjacent track is destroyed by collision or the like is raised. When the recording mark is shortened, the amount of data which may be destroyed before the track jump is detected and the recording is interrupted is increased. Thus, it may become difficult to perform reproduction beyond the limit of error correction.

Tracking is performed based on a tracking error signal generated from light reflected by the optical disc. When a plurality of recording layers are stacked, light reflected by the target recording layer is overlapped by light reflected by an adjacent recording layer (hereinafter, referred to as “stray light”), which adversely influences the tracking error signal. Therefore, unintentional track jump easily occurs, and the possibility that data in an adjacent track or a track in the vicinity of the target track is destroyed is raised. In the field of optical discs, Blu-ray discs including three recording layers are provided as products. In the future, optical discs including a larger number of recording layers, for example, eight layers, 16 layers and the like may be possibly developed. In such a case, control on tracking is expected to be more difficult. In addition, stray light causes an error to an error signal, and thus makes it difficult to detect the head jumping the target track and jumping to another track. If an error is caused to a tracking error signal, even though the head does not jump to another track, the optical spot follows a position which is offset from the center of the track. As a result, leak of the signal to an adjacent track (called “crosstalk”) or overwriting of data on one side of an adjacent track with respect to the recording mark (called “cross erase”) easily occurs. As the distance between the recording layers is shortened, the amount of stray light is increased and the influence of the stray light is increased. Thus, as the number of stacked recording layers is increased, the possibility that data in the adjacent track is destroyed is raised.

The present invention made in light of the above-described problem provides a recording/reproduction device and a recording/reproduction method, by which it is checked whether or not latest management information can be reproduced correctly after management information is recorded and thus the reliability of the management information can be improved.

### Solution to Problem

A recording/reproduction device according to the present invention includes a recording/reproduction section for recording or reproducing data on or from an information recording medium; a verification section for reproducing the data recorded on the information recording medium by use of the recording/reproduction section and checking whether or not the data can be reproduced normally; a management information recording section for recording, on the information recording medium by use of the recording/reproduction section, only management information which needs to be changed among a plurality of types of management information for managing the data recorded on the information recording medium; and a management information checking section for checking, by use of the verification section, whether or not latest management information including management information which does not need to be changed and is to be reused can be reproduced normally.

In an embodiment, in the case where the latest management information is recorded on the information recording medium discontinuously and management information different from the latest management information is recorded between positions at which the latest management information is recorded, the management information checking section does not reproduce the management information different from the latest management information during an operation of checking the latest management information.

In an embodiment, in the case where the management information checking section confirms that the latest management information cannot be reproduced normally, the management information recording section re-records the management information which is not reproduced normally among at least the latest management information.

In an embodiment, at least one of the plurality of types of management information includes management information position information which indicates a position at which the other types of management information are recorded; and the management information checking section specifies a position at which the management information to be reused is recorded, based on the management information position information.

In an embodiment, the plurality of types of management information are defect management information for managing a defective area of the information recording medium, recording management information indicating a recording state of the information recording medium, and a disc definition structure indicating a structure of the information recording medium; the disc definition structure includes defect management information position information indicating a position at which the defect management information is recorded, and recording management information position information indicating a position at which the recording management information is recorded; and the management information checking section specifies a position at which the management information to be reused is recorded, based on the defect management information position information and the recording management information position information.

In an embodiment, in the case where recording of the management information which needs to be changed is successful with a retry, the management information checking section checks whether or not the latest management information including the management information to be reused can be reproduced normally; and in the case where recording of the management information which needs to be changed is successful with no retry, the management information checking section checks whether or not the recorded management information which needed to be changed can be reproduced normally, but does not check whether or not the management information to be reused can be reproduced normally.

In an embodiment, the management information checking section sets, as a checking target, only the latest management information recorded at a radial position within a prescribed range from a radial position at which the management information which needs to be changed is recorded.

A recording/reproduction method according to the present invention includes step (a) of recording data on an information recording medium; step (b) of checking whether or not the data recorded on the information recording medium can be reproduced normally; step (c) of recording, on the information recording medium, only management information which needs to be changed among a plurality of types of management information for managing the data recorded on the information recording medium; and step (d) of checking whether or not latest management information including management information which does not need to be changed and is to be reused can be reproduced normally.

In an embodiment, in the case where the latest management information is recorded on the information recording medium discontinuously and management information different from the latest management information is recorded between positions at which the latest management information is recorded, the management information different from the latest management information is not reproduced in step (d).

In an embodiment, in the case where it is confirmed that the latest management information cannot be reproduced normally, the management information which is not reproduced normally among at least the latest management information is re-recorded.

In an embodiment, at least one of the plurality of types of management information includes management information position information which indicates a position at which the other types of management information are recorded; and in step (d), a position at which the management information to be reused is recorded is specified based on the management information position information.

In an embodiment, the plurality of types of management information are defect management information for managing a defective area of the information recording medium, recording management information indicating a recording state of the information recording medium, and a disc definition structure indicating a structure of the information recording medium; the disc definition structure includes defect management information position information indicating a position at which the defect management information is recorded, and recording management information position information indicating a position at which the recording management information is recorded; and in step (d), a position at which the management information to be reused is recorded is specified based on the defect management information position information and the recording management information position information.

In an embodiment, in the case where recording of the management information which needs to be changed is successful with a retry, step (d) is executed; and the recording/reproduction method further comprises step (e) of, in the case where recording of the management information which needs to be changed is successful with no retry, checking whether or not the management information which needed to be changed, which is a part of the latest management information, can be reproduced normally.

In an embodiment, in step (d), only the latest management information, recorded at a radial position within a prescribed range from a radial position at which the management information which needs to be changed is recorded, is set as a checking target.

A program according to the present invention is a program for causing a recording/reproduction device to record or reproduce data on or from an information recording medium. The program causes the recording/reproduction device to execute step (a) of recording data on an information recording medium; step (b) of checking whether or not the data recorded on the information recording medium can be reproduced normally; step (c) of recording, on the information recording medium, only management information which needs to be changed among a plurality of types of management information for managing the data recorded on the information recording medium; and step (d) of checking whether or not latest management information including management information which does not need to be changed and is to be reused can be reproduced normally.

### Advantageous Effects of Invention

According to the present invention, even if the latest management information is unintentionally destroyed during recording, it can be detected with certainty that the latest management information cannot be reproduced. When management information which cannot be reproduced is detected, such management information is re-recorded in a management information area. Thus, it is guaranteed that all the latest management information recorded in the management information area can be reproduced correctly.

Substantially the same effect is provided even when the latest management information cannot be reproduced due to a scratch or dust on the disc after the latest management information is recorded.

According to the present invention, the positions of a plurality of elements of the latest management information are specified, and verification is performed only on the areas where the elements are recorded. Therefore, the area for which verification is to be performed can be minimized. Thus, the time duration required for the verification can be minimized, and it can be determined at higher speed and with certainty whether or not the management information can be reproduced correctly. Even if there is a defective cluster between areas where the latest management information is recorded, data is not reproduced from such a defective area. Thus, it can be determined at higher speed whether or not the management information can be reproduced correctly.

It is not necessary to reproduce and retain data other than the latest management information before the recording. Therefore, the increase of capacity of the buffer or memory, which is needed to expand the area where data can be protected, can be minimized. Thus, it can be determined at the minimum cost, at higher speed and with certainty whether or not the latest management can be reproduced correctly.

### BRIEF DESCRIPTION OF DRAWINGS

FIG. 1 shows an overall structure of an information recording medium in Embodiment 1 according to the present invention.

FIG. 2 shows an area structure of the information recording medium in Embodiment 1 according to the present invention.

FIG. 3 shows an area structure of a DMA in the information recording medium in Embodiment 1 according to the present invention.

FIG. 4 shows a data structure of a TDFL in the information recording medium in Embodiment 1 according to the present invention.

FIG. 5 shows a data structure of an SRRI in the information recording medium in Embodiment 1 according to the present invention.

FIG. 6 shows a data structure of a TDDS in the information recording medium in Embodiment 1 according to the present invention.

FIG. 7 shows a structure of an information recording/reproduction device in Embodiment 1 according to the present invention.

FIG. 8 is a flowchart showing a method for acquiring latest management information from a TDMA in Embodiment 1 according to the present invention.

FIG. 9 is a flowchart showing a method for recording user data on the information recording medium in Embodiment 1 according to the present invention.

FIG. 10 is a flowchart showing a method for recording management information in the TDMA in Embodiment 1 according to the present invention.

FIG. 11 shows a state of the TDMA after the SRRI is updated in Embodiment 1 according to the present invention.

FIGS. 12(a) and (b) each show a state of the TDMA after a TDFL is recorded in an updated manner in Embodiment 1 according to the present invention.

FIGS. 13(a) and (b) each show an example of management information recorded in a TDMA in a BD-R.

FIG. 14 shows an area structure of an information recording medium in Embodiment 2 according to the present invention.

FIG. 15A shows a directory structure of the information recording medium in Embodiment 2 according to the present invention.

FIG. 15B shows a data structure of a user data area in which file data is recorded in Embodiment 2 according to the present invention.

FIG. 15C shows a data structure of the user data area in which File A is recorded in an updated manner in Embodiment 2 according to the present invention.

### DESCRIPTION OF EMBODIMENTS

Hereinafter, embodiments of the present invention will be described with reference to the drawings.

### Embodiment 1

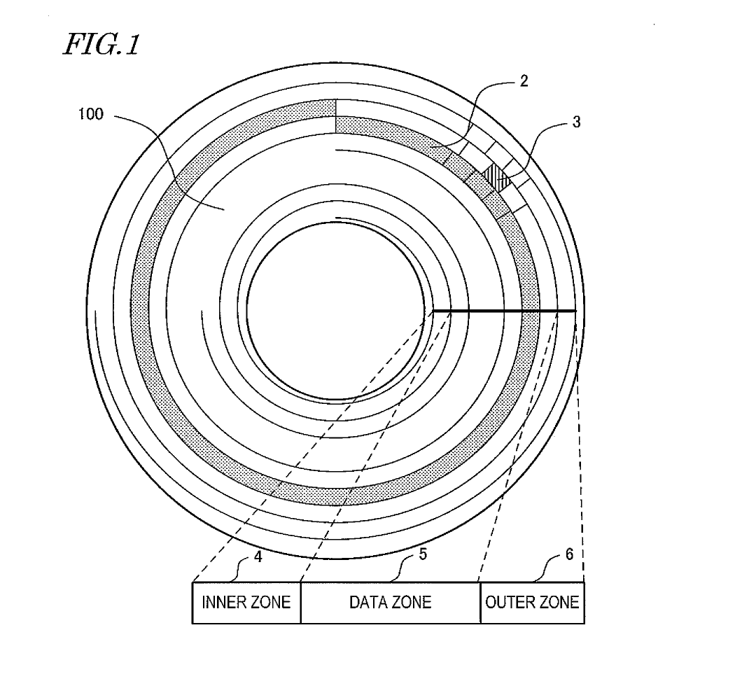

FIG. 1 shows an overall structure of an information recording medium in Embodiment 1 according to the present invention. In Embodiment 1 according to the present invention, a single layer BD-R including a single recording layer is used as an information recording medium 100. In the following description, recording is performed on the BD-R in a sequential recording mode.

The information recording medium 100 having a disc-like shape includes tracks 2 (guide grooves) formed in a spiral manner. Each track 2 is divided into a great number of minute clusters 3. A “cluster” 3 is an error correction unit and is a minimum unit by which recording and reproduction operations are performed, and may also be called an “ECC block”. In a BD, one cluster includes 32 sectors (one sector has 2 kbytes, and one cluster has 64 kbytes).

An area of the information recording medium 100 is roughly divided into an inner zone 4, a data zone 5 and an outer zone 6. User data is recorded in, or reproduced from, the data zone 5. The inner zone 4 is also called a “lead-in zone”, and the outer zone 6 is also called a “lead-out zone”. The inner zone 4 and the outer zone 6 each act as a margin, such that even if a head (not shown) overruns in an attempt to access an end of the data zone 5, the head can still follow the track. Such an area structure is common to a rewritable information recording medium and a write-once read-many information recording medium.

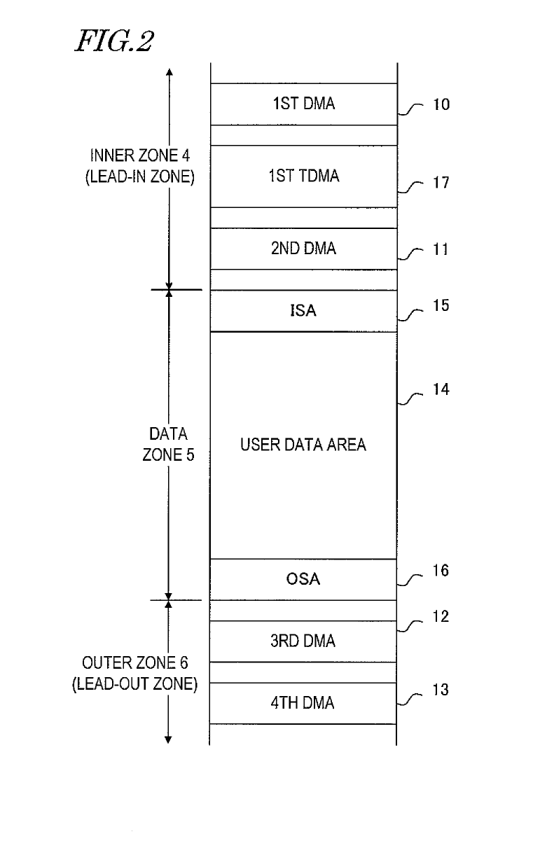

FIG. 2 shows an area arrangement of the information recording medium 100 in Embodiment 1 according to the present invention.

The data zone 5 includes a user data area 14 in which user data is to be recorded, and an ISA (Inner Spare Area) 15 and an OSA (Outer Spare Area) 16, which are spare areas each prepared in advance as a block usable instead of a defective block in the user data area 14 (hereinafter, each referred to as a “replacement block”).

The inner zone 4 and the outer zone 6 each include two DMAs (Disc (or Defect) Management Areas) in which management information is to be recorded; namely, four DMAs in total are included in the information recording medium 100. Specifically, the inner zone 4 includes a first DMA 10 and a second DMA 11, and the outer zone 6 includes a third DMA 12 and a fourth DMA 13. The same management information is recorded in all the DMAs in an overlapping manner in order to raise the redundancy as a preparation for the case where a DMA among the DMAs is defective.

The lead-in zone (inner zone) 4 further includes a first TDMA (Temporary Disc (or Defect) Management Area) 17. A TDMA is specific to a write-once read-many information recording medium which does not allow rewriting (overwriting). The TDMA 17 is used to write-once temporary management information for update while the information recording medium 100 is being used.

Although not shown in FIG. 2, the ISA 15 or the OSA 16 may include a reserve TDMA in a part thereof. Such a reserve TDMA is used when the first TDMA 17 is used up. In the following, the first TDMA 17 will be referred to simply as the “TDMA 17”.

In the TDMA 17, a TDMS, which is a management information structure regarding the information recording medium 100, is recorded. The TDMS includes three types of management information, namely, a TDFL 400, an SRRI 500, and a TDDS 600. These will be described later in detail.

In the TDMA 17, the management information is recorded on a basis of an update unit called “TDMS Update Units” in order to suppress the area consumption described above. For recording the management information in the TDMA 17, the management information which has been recorded previously and has not been changed is reused. The recording is performed on a basis of a TDMS Update Unit formed of only the management information which needs to be updated.

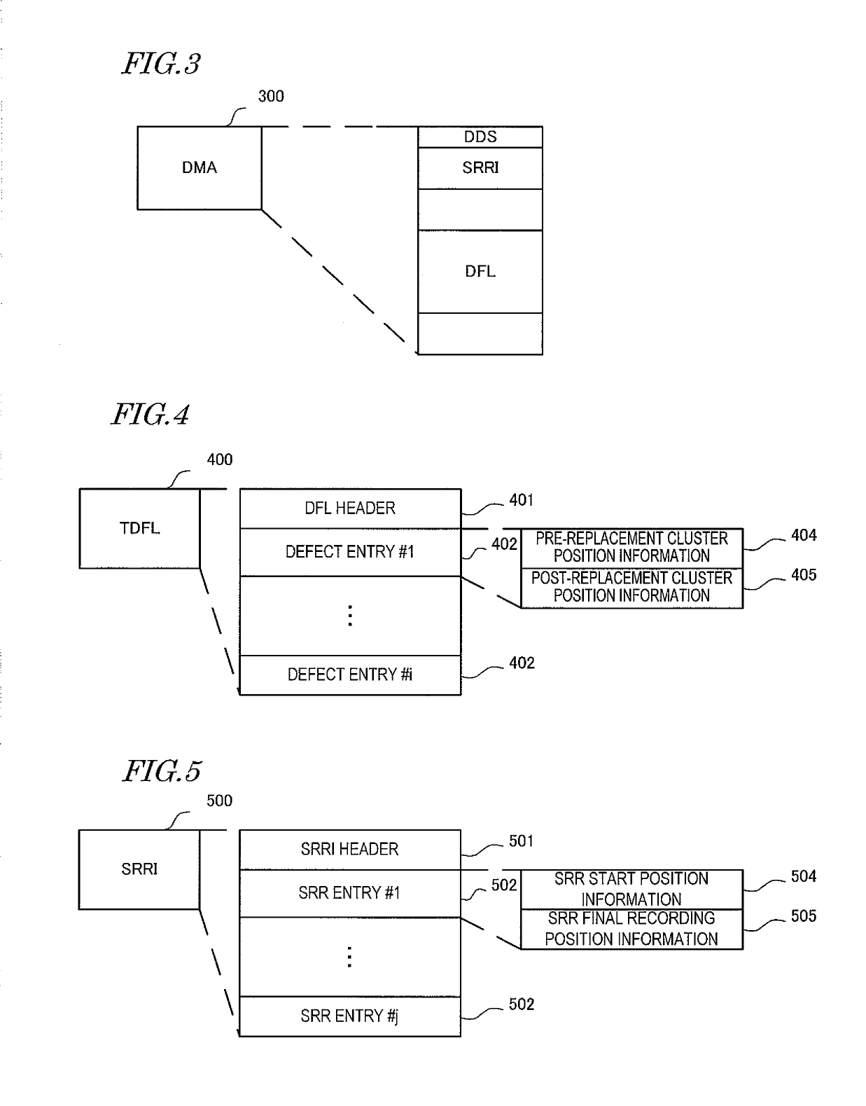

FIG. 3 shows an area arrangement of a DMA in the information recording medium 100 in Embodiment 1 according to the present invention, in which fixed management information is to be recorded.

In the DMAs, a disc definition structure (hereinafter, referred to as a “DDS”) including layout information of the disc and the like, an SRRI indicating a recording state of the user data area, and defect management information (Defect List; hereinafter, referred to as a “DFL”) including position information on a defect, position information on a post-replacement area, and the like are recorded. The TDDS and the TDFL described above both have a first letter “T”, which represents “temporary”. The TDDS and the TDFL are so called because these are information to be recorded in the TMDA 17. In the DMAs in which fixed management information is to be recorded, the DDS and the DFL are recorded. The DDS and the DFL respectively have the same data structures as those of the TDDS 600 and the TDFL 400.

In the DMAs, the latest management information which forms the latest TDMS is recorded. The latest TDMS is recorded in the TDMA at the time of finalizing (disc closing), namely, when subsequent data recording (write-once) on the information recording medium 100 is prohibited and the information recording medium 100 is made exclusively for reproduction.

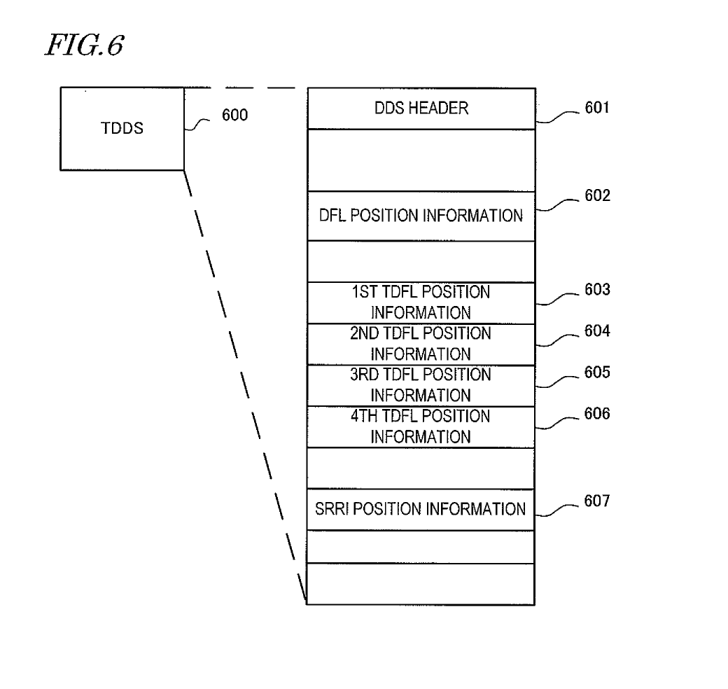

FIG. 4 shows a data structure of the TDFL 400 in the information recording medium 100 in Embodiment 1 according to the present invention.

The TDFL 400 includes a DFL header 401 and at least zero defect entry 402. Each defect entry 402 includes pre-replacement cluster position information 404 which indicates, for example, a position of a defect cluster detected at the time of recording or reproduction performed in or from the user data area, or a position of a cluster requested to be rewritten by a logical overwriting function (hereinafter, referred to simply as a “LOW function”) included in the BD-R. Each defect entry 402 also includes post-replacement cluster position information 405 which indicates a position of a post-replacement cluster such as a spare area assigned instead of the pre-replacement cluster. The pre-replacement cluster position information 404 and the post-replacement cluster position information 405 are each, for example, position information (physical address) of a leading sector of the respective cluster. The DFL header 401 includes, for example, the number of defect entries 402 included in the TDFL. The TDFL 400 has a length variable in accordance with the number of defect clusters detected at the time of recording or reproduction performed in or from the user data area 14, and may be recorded over a plurality of clusters. In Embodiment 1 according to the present invention, the TDFL is formed of, for example, four clusters at the maximum.

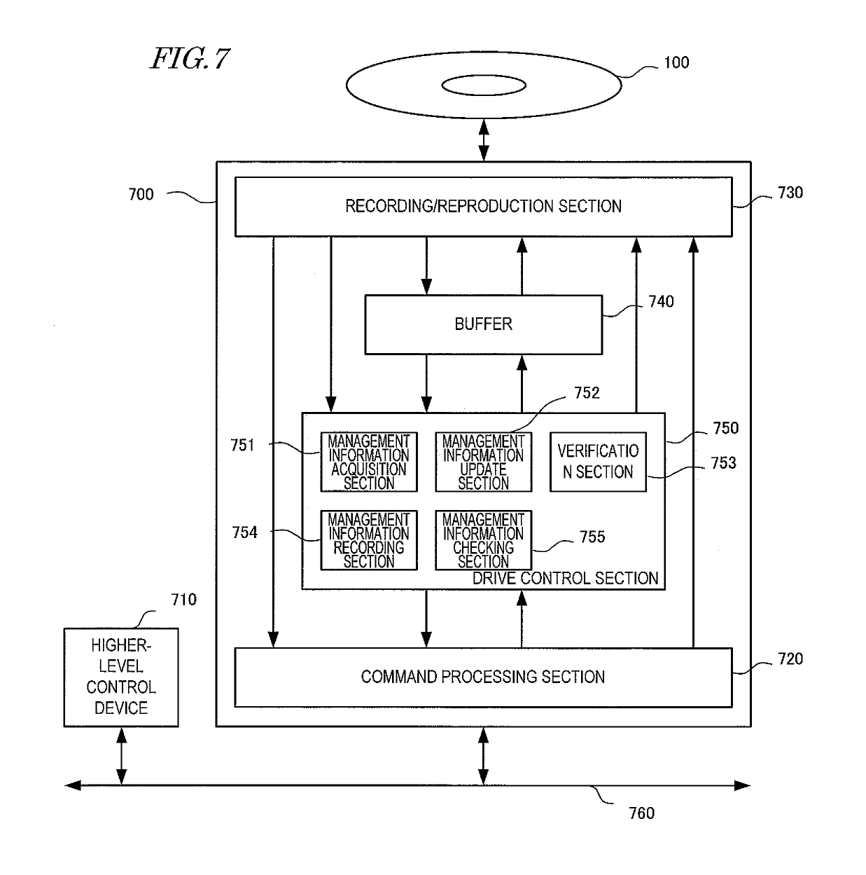

FIG. 5 shows a data structure of the SRRI 500 in the information recording medium 100 in Embodiment 1 according to the present invention.

The SRRI 500 includes an SRRI header 501 and at least one SRR entry 502. Each SRR entry 502 includes SRR start position information 504 which indicates a start position of the SRR, and SRR final recording position information 505 which indicates a final recording position in the SRR. The final recording position information is also called an “LRA” (Last Recorded Address). The SRRI header 501 includes, for example, the number of entries 502 included in the SRRI 500. In Embodiment 1 according to the present invention, the SRRI has a size accommodated in, for example, 30 sectors at the maximum.

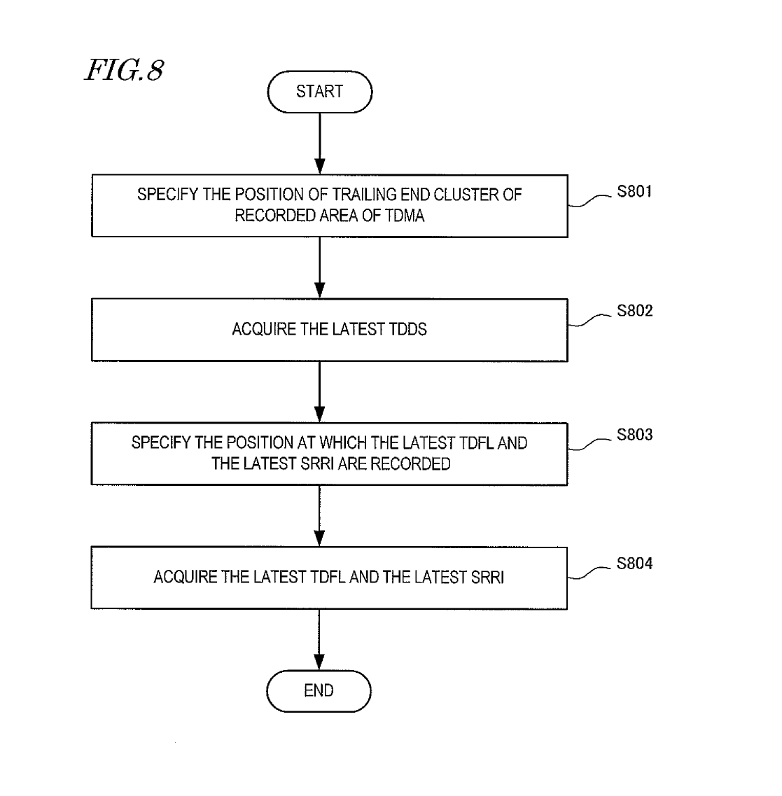

FIG. 6 shows a data structure of the TDDS 600 in the information recording medium 100 in Embodiment 1 according to the present invention.

The TDDS 600 includes information for managing the management information, for example, position information on a position at which the management information such as the TDFL 400, the SRRI 500 and the like is recorded. The TDDS 600 is information of a fixed size. In Embodiment 1 according to the present invention, the size of the TDDS 600 is, for example, 1 sector.

The TDDS 600 includes, for example, a DDS header 601 including an update time number, which indicates the number of times the TDDS is recorded in an updated manner; DFL position information 602 on a position of the DFL recorded in the DMAs, first TDFL position information 603, second TDFL position information 604, third TDFL position information 605 and fourth TDFL position information 606 which are for managing a position of the latest TDFL 400 recorded in the TDMA in units of clusters; and SRRI position information 607, which indicates a position of the latest SRRI recorded in the TDMA.

The latest TDDS 600, the TDFL 400 recorded in the clusters indicated by the first through fourth TDFL position information 603 through 606 stored in the latest TDDS, and the SRRI 500 recorded in the cluster indicated by the SRRI position information 607 are the latest management information (latest TDMS).

The TDFL 400 is formed of four clusters at the maximum. Therefore, the TDDS 600 includes information regarding the first through fourth TDFL positions, namely, four TDFL positions which indicates the positions of the respective four clusters. The number of clusters of the TDFL 400 to be recorded in the TDMA 17 varies in accordance with the number of the defect entries 402. In this case, in the information indicating the position of the TDFL which is not recorded in the TDMA 17, invalid position information indicating that no TDFL cluster exists, for example, 0, is stored. For example, when the effective size of the TDFL 400 is two clusters, in the first TDFL position information 603 and the second TDFL position information 604, information regarding the positions of the respective clusters recorded in the TDMA 17 is stored; whereas in the third TDFL positions information 605 and the fourth TDFL position information 606, is stored. Similarly, regarding the DFS position information 602 on the position of the DFL recorded in the DMAs, in the TDDS 600 recorded in the TDMA 17, a value which indicates that the information 602 is invalid, for example, 0, is stored.

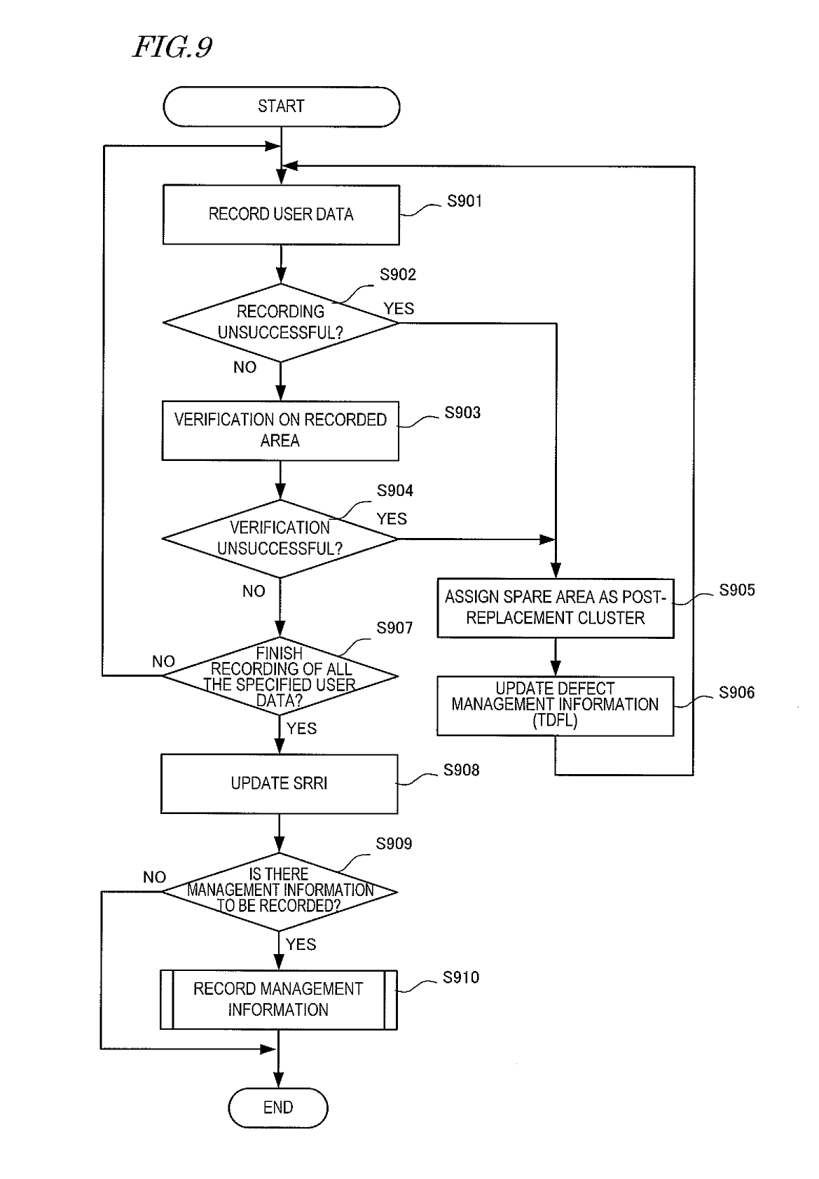

FIG. 7 shows a structure of an information recording/reproduction device 700 in Embodiment 1 according to the present invention.

The information recording/reproduction device 700 is connected to a higher-level control device 710 via an I/O bus 760. The higher-level control device 710 is, for example, a host computer.

The information recording/reproduction device 700 includes a command processing section 720, a recording/reproduction section 730, a buffer 740, and a drive control section 750.

The command processing section 720 processes a command from the higher-level control device 710.

The recording/reproduction section 730 performs recording or reproduction of data in units of clusters on or from the information recording medium 100 in accordance with an instruction from the command processing section 720 and the drive control section 730.

The buffer 740 temporarily stores user data to be recorded or reproduced, stores the latest information of DDS, SRRI and DFL as the management information, or stores a TDFL update flag indicating that the content of the DFL (TDFL) stored in the buffer 740 has been changed, an SRRI update flag indicating that the content of the SRRI has been changed, and the like.

The drive control section 750 includes a management information acquisition section 751, a management information update section 752, a verification section 753, a management information recording section 754, and a management information checking section 755.

The management information acquisition section 751 controls the recording/reproduction section 730 to read the latest management information from the TDMA 17 and store (cache) the read information in the buffer 740.

The management information update section 752 updates (changes) the content of the management information stored in the buffer 740.

The verification section 753 controls the recording/reproduction section 730 to reproduce data from a prescribed cluster and checks based on the reproduction result whether or not the data has been reproduced correctly. For example, when the data is reproduced and an error correction is made, the verification section 753 determines that the data has been reproduced correctly. Alternatively, when the data is reproduced and the reproduced data matches the data to be recorded, the verification section 753 may determine that the data has been reproduced correctly.

The management information recording section 754 selects the management information which needs to be recorded on the information recording medium 100 in an updated state, generates management information to be recorded in the TDMA 17, and controls the recording/reproduction section 730 to record the generated information in the TDMA 17.

The management information checking section 755 has a function of performing verification on both of the management information recorded in an updated state and the management information reused by use of the verification section 753, and checking whether or not the latest management information can be reproduced correctly.

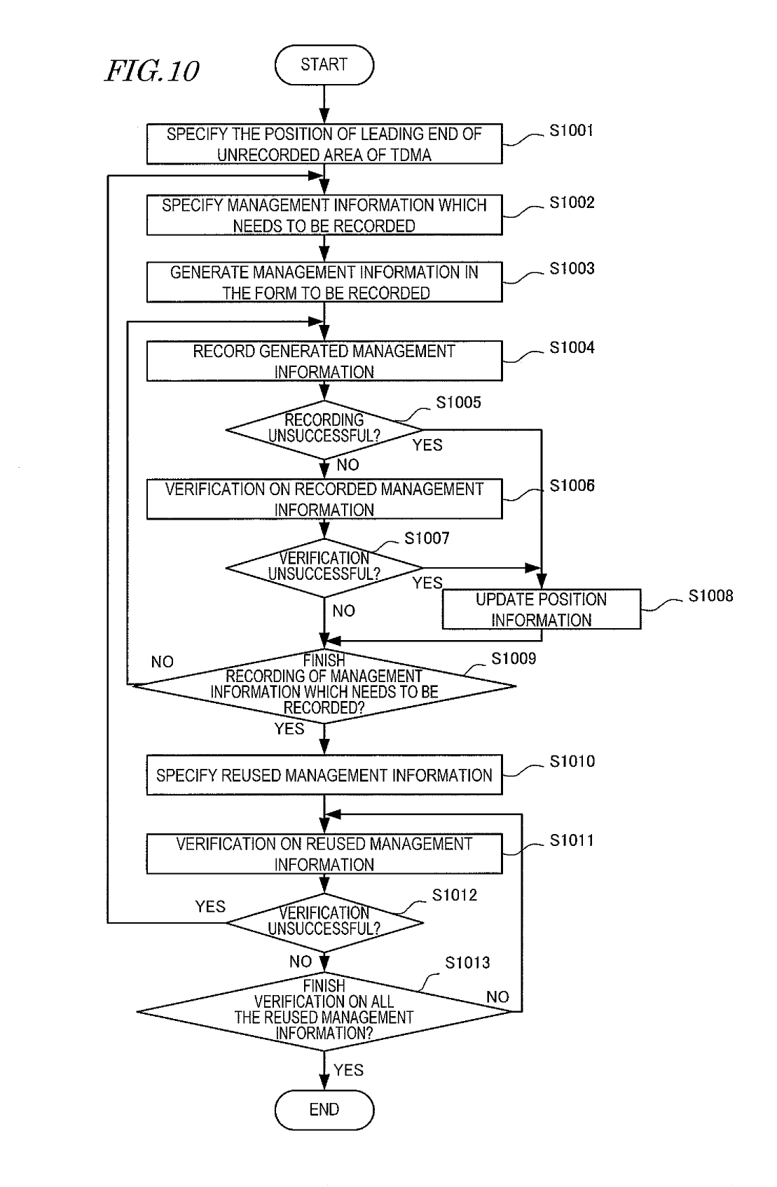

FIG. 8 is a flowchart showing a method for acquiring the latest management information from the TDMA 17 in Embodiment 1 according to the present invention.

This process is performed after the information recording medium 100 is mounted before the user data is recorded or reproduced.

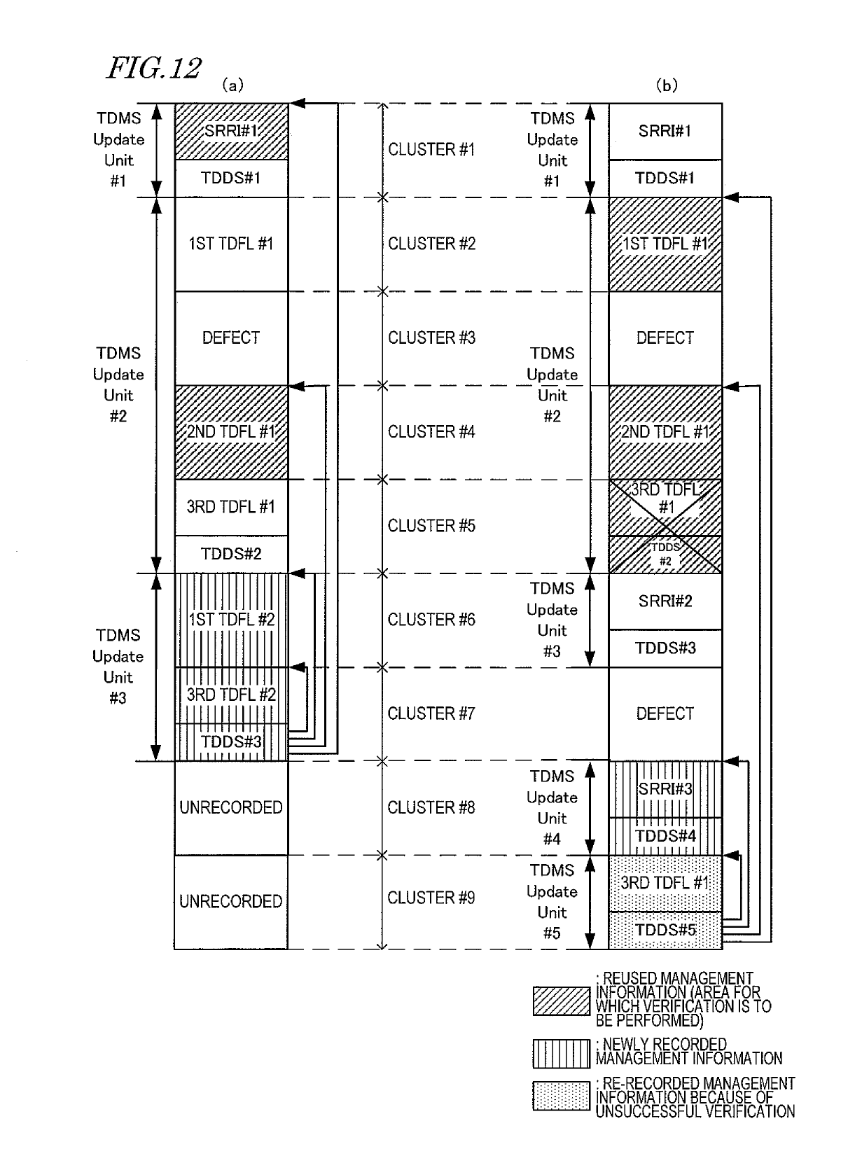

In step 801, the management information acquisition section 751 detects the position of a border between a recorded area and an unrecorded area of the TDMA 17 based on, for example, a reproduction signal from the information recording medium 100, and specifies the position of a trailing end cluster of the recorded area of the TDMA 17. The border position between the recorded area and the unrecorded area of the TDMA 17 which is determined in step 801 (namely, next TDMA recording position, which is the position of a leading end from which the management information is recorded in the TDMA 17 the next time) may be retained in a part of the buffer 740, a memory (not shown) or the like. As described above, before the user data is recorded or reproduced on or from the information recording medium 100, the reproduction process of the management information (TDMS) shown in FIG. 8 needs to be performed. As described later, for recording new management information in the TDMA 17 (FIG. 10), information regarding the next TDMA recording position is always needed. Specifically, the next TDMA recording position is equivalent to information specified in step 1001 described later. Therefore, it is desirable that the information regarding the next TDMA recording position determined in step 801 is stored in the buffer 740, a memory or the like so as to be usable in later processes.

The latest TDDS 600 is necessarily recorded in a final sector of the trailing end cluster of the recorded area of the TDMA 17. Therefore, in step 802, the management information acquisition section 751 controls the recording/reproduction section 730 to reproduce data from the cluster at the trailing end of the recorded area in TDMA 17, which is detected in step 801. Owing to this, the latest TDDS 600 is read to, and stored in, the buffer 740.

In the latest TDDS 600, the position information of the latest TDFL 400 and the latest SRRI 500 is recorded. Therefore, in step 803, the management information acquisition section 751 specifies the position of the cluster in which the latest TDFL 400 and the latest SRRI 500 are recorded, based on the TDFL position information 603 through 606 and the SRRI position information 607 included in the TDDS read to the buffer 740.

In step 804, the management information acquisition section 751 controls the recording/reproduction section 730 to reproduce the data from the cluster specified in step 803. Owing to this, the latest TDFL 400 and the latest SRRI 500 are read to, and stored in, the buffer 740.

By the above-described procedure, the TDDS, the TDFL, and the SRRI forming the latest management information (latest TDMS) are read to, and stored in, the buffer 740.

In step 804, it is described that the data is reproduced from the cluster indicated by the TDFL position information 603 through 606 and the SRRI position information 607 specified in step 803. The TDDS 600 is combined with, and recorded in the same cluster as, the TDFL 400 and the SRRI 500. Therefore, a part of the management information of the TDFL 400 or the SRRI 500 which is recorded in combination with the TDDS 600 in the trailing end cluster of the recorded area of the TDMA 17 is already reproduced in step 802 and thus does not need to be reproduced in step 804.

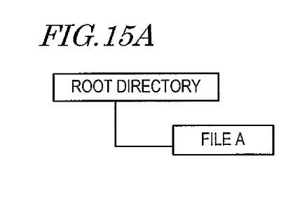

With reference to FIG. 13(a), the above-described process will be described specifically.

In step 801, the border position between cluster #5 and cluster #6 is detected as the border between the recorded area and the unrecorded area. Cluster #5 is specified as the trailing end cluster of the recorded area.

In step 802, data is reproduced from cluster #5. As a result, the latest TDDS 600, namely, TDDS #2, is stored in the buffer 740.

In step 803, as the information regarding the position of the latest TDFL 400 (the first TDFL position information 603, the second TDFL position information 604, and the third TDFL position information 605), the position of cluster #2 in which first TDFL #1 is recorded, the position of cluster #4 in which second TDFL #1 is recorded, and the position of cluster #5 in which third TDFL #1 is recorded are acquired. As the information regarding the position of the latest SRRI 500, the position of cluster #1 in which SRRI #1 is recorded is specified.

In step 804, data is reproduced from cluster #1, cluster #2 and cluster #4. As a result, first TDFL #1, second TDFL #1 and SRRI #1 are stored in the buffer 740. Third TDFL #1 is recorded in cluster #5 in which TDDS #2 is also recorded, and therefore is already stored in the buffer 740 and does not need to be reproduced again in step 804.

As a result of the above-described process, the latest information, namely, SRRI #1, first TDFL #1, second TDFL #1, third TDFL #1 and TDDS #2 are all acquired and stored in the buffer 740.

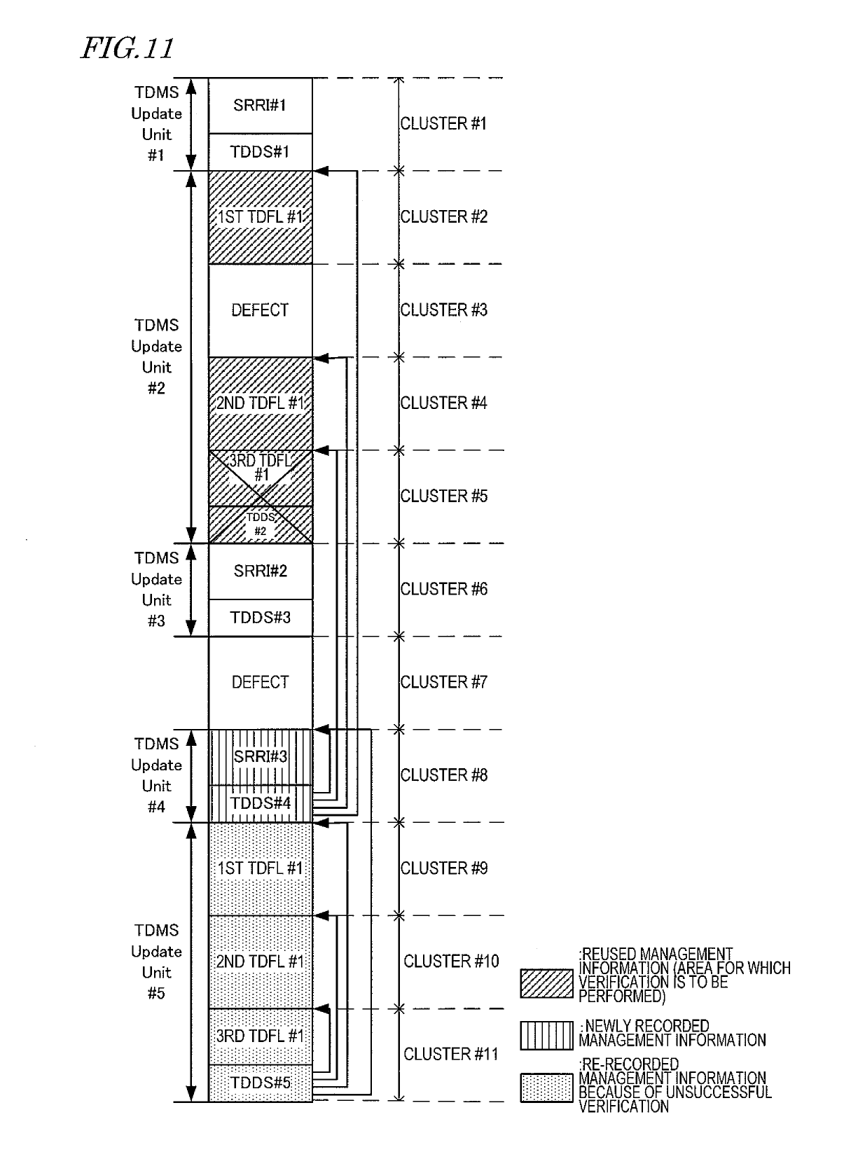

FIG. 9 is a flowchart showing a method for recording the user data on the information recording medium 100 in Embodiment 1 according to the present invention.

The command processing section 720, upon receiving a command to record from the higher-level control device 701, instructs the recording/reproduction section 730 to record the user data sent along with the command to record. As the command to record, information on a start position of an area in which the user data is to be recorded and the number of clusters of the area are specified. When instructed to record, the recording/reproduction section 730 records the user data based on the start position instructed by the higher-level device.

In step 901, the recording/reproduction section 730 records the user data in the user data area 14 or the spare area (ISA 15, OSA 16). The user data is recorded in the spare area in the case where in step 905 described later, the spare area is assigned as the post-replacement cluster.

In step 902, the recording/reproduction section 730 determines whether or not the recording in step 901 is unsuccessful. When the recording is unsuccessful, the process goes to step 905. When the recording is successful, the process goes to step 903. The recording is considered to be unsuccessful in the case where, for example, an error occurs during the recording, or the head does not reach the position of the cluster where the recording is to be performed and the recording is not started.

In step 903, the verification section 753 instructs the recording/reproduction section 730 to reproduce the data from the area in which the data has been recorded in step 901, and thus performs verification of determining whether or not the data can be reproduced correctly. When the verification is successful, it is determined that the data is reproduced correctly. When the verification is unsuccessful, it is determined that the data is not reproduced correctly. Owing to this, it can be determined whether or not the user data is recorded normally. The data is considered to be reproduced correctly in the case where, for example, the data is read within a prescribed number of error corrections.

When it is determined in step 904 that the data is reproduced correctly in step 903, namely, when the user data is recorded normally, the process goes to step 907. When it is determined in step 904 that the data is not reproduced correctly in step 903, namely, when the user data recorded in step 901 is not reproduced normally, the process goes to step 905. The user data recorded in step 901 is not reproduced normally in the case where, for example, the cluster where the data is recorded is defective, or the adequate recording is not performed due to an insufficient recording power caused by dust or fingerprint attached to the surface of the information recording medium 100.

In step 905, the recording/reproduction section 730 assigns the spare area as a post-replacement cluster in order to record, in a replacing manner, the user data which was to be recorded in the cluster for which the recording or verification is unsuccessful (i.e., defective cluster). The recording in the post-replacement cluster is performed in step 901.

In step 906, the management information update section 752 updates the TDFL stored in the buffer 740. When, for example, a defect is detected during the recording of the user data, the defect entry 402 is added to the TDFL stored in the buffer 740, and the number of the defect entries included in the DFL header is increased by one. The defect entry 402 has the pre-replacement cluster position information 404, which indicates the position of the cluster in the user data 14 where it was first attempted to record the data in step 901, and the post-replacement cluster position information 405, which indicates the position of the cluster in the spare area assigned in step 905. When a defect is detected during the recording in a cluster in the spare area assigned as the post-replacement cluster, another post-replacement cluster is assigned in step 905, and the TDFL stored in the buffer 740 is updated such that the post-replacement cluster position information 405 in the defect entry 402 which was attempted to be added is changed to the position of the re-assigned cluster. The management update section 752 sets the TDFL update flag to 1, which indicates that the content of the TDFL in the buffer 740 has been updated (changed). Then, in order to record, in a replacing manner, the data in the post-replacement cluster assigned in step 905, the process is repeated from step 901.

In step 907, the recording/reproduction section 730 determines whether or not all the user data specified by the higher-level control device 710 has been recorded. For example, it is determined whether or not the recording has been completed in the number of clusters specified by the higher-level device. When all the specified user data has been recorded, the process goes to step 908. When all the specified user data has not been recorded, the process goes to step 901 in order to record the remaining user data. Then, steps 901 through 907 are repeated until all the specified user data is recorded.

The recording of the user data specified by the higher-level control device 710 is now finished. Therefore, in step 908, the management information update section 752 updates the SRR final recording position information 505 (LRA) to the position at which the recording of the user data is finished. The SRR final recording position information 505 (LRA) is in the SRR entry 502, in the SRRI stored in the buffer 740, corresponding to the SRR in which the user data is recorded. The management information update section 752 also sets the SRRI update flag to 1, which indicates that the content of the SRRI in the buffer 740 has been updated (changed).

In step 909, the management information recording section 754 determines whether or not there is management information to be recorded in the TDMA. For example, when the TDFL update flag or the SRRI update flag is 1, it is determined that there is management information to be recorded. When the TDFL update flag and the SRRI update flag are both 0, it is determined that there is no management information to be recorded. When it is determined that there is management information to be recorded, the process goes to step 910. When it is determined that there is no management information to be recorded, the process is finished.

In step 910, the management information to be recorded in the TDMA is recorded.

In step 909, it is described that when the TDFL update flag or the SRRI update flag is 1, it is determined that there is management information to be recorded. However, the manner of determination is not limited to this.

Regarding step 909, the SRR final recording position information 505 (LRA) of the SRRI stored in the buffer 740 is updated in step 908. Therefore, the SRRI is necessarily recorded after the recording of the user data is finished. However, when the TDMA 17 is used up, data management cannot be performed, and thus the user data cannot be recorded.

Therefore, for example, the number of clusters in which data has been recorded may be counted, so that it is determined that the management information needs to be recorded in the TDMA when at least a prescribed number of clusters are used for recording.

For example, it may be determined that the management information needs to be recorded in the TDMA when the difference between the value of the LRA in the SRRI which is already reflected in the TDMA and the value of the LRA in the SRRI in the buffer 740 is equal to or greater than a prescribed value.

For example, it may be determined that the management information needs to be recorded in the TDMA when the number of times the recording instruction is issued from the higher-level control device 710 reaches the a prescribed value.

For example, the position at which the recording is finished may be retained in the buffer 740, it is determined that the management information needs to be recorded in the TDMA when the position of the cluster at which the recording is to be started as specified by the higher-level control device 710 is different from the position at which the immediately previous recording is finished.

For example, the time at which the recording in the TDMA is performed may be retained in the buffer 740, so that it is determined that the management information needs to be recorded in the TDMA when a prescribed time duration elapses from the time.

For example, the number of times of update may be counted, so that it is determined that the management information needs to be recorded in the TDMA when the number of times of update exceeds a prescribed value.

For example, the number of added and changed defect entries may be counted, so that it is determined that the management information needs to be recorded in the TDMA when a prescribed number of defect entries are added and changed.

For example, it may be determined whether or not the number of defect entries included in the DFL header has increased, so that it is determined that the management information needs to be recorded in the TDMA when the number of defect entries included in the DFL header has increased.

These various determination criteria are described as being adopted in step 909. Alternatively, substantially the same determination criteria may be adopted in step 908 or step 906. For example, in step 908, the SRRI update flag may be set to 1 when the difference between the value of the LRA in the SRRI which is already reflected in the TDMA and the value of the LRA in the SRRI in the buffer 740 is equal to or greater than a prescribed value.

In the case where the management information is necessarily recorded after the recording of the user data is finished, step 909 can be omitted.

FIG. 10 is a flowchart showing a method for recording the management information in the TDMA in Embodiment 1 according to the present invention.

In step 1001, the management information recording section 754 detects the border position between the recorded area and the unrecorded area the TDMA based on the reproduction signal or the like, and specifies the position of a leading end of the unrecorded area of the TDMA. When recording the management information in the following steps, the recording is performed sequentially from the position of the leading end.

In step 1001, it is not absolutely necessary to access the information recording medium 100 to detect the border position between the recorded area and the unrecorded area of the TDMA (namely, the next TDMA recording position, which is the position of the leading end from which the management information is recorded in the TDMA the next time) by use of the reproduction signal or the like. Specifically, in the case where the next TDMA recording position is determined in step 801 shown in FIG. 8 descried above and the information thereon is stored in the buffer, the memory or the like, it is merely required in step 1001 to acquire such information stored in the buffer or the memory. The information regarding the next TDMA recording position stored in the buffer or the memory is updated at, for example, the timing when management information (TDMS) is newly recorded in the TDMA (step 1004 described later, etc.).

In step 1002, the management information recording section 754 specifies the management information which needs to be recorded in the TDMA. The management information recording section 754 uses, for example, an update flag indicating the type of updated management information (TDFL update flag or SRRI update flag) to specify the management information which needs to be recorded in the TDMA. For example, when the TDFL update flag is 1, it is determined that the management information which needs to be reflected in the TDMA is the TDFL and the TDDS. Similarly, when the SRRI update flag is 1, it is determined that the management information which needs to be reflected in the TDMA is the SRRI and the TDDS. The TDDS necessarily needs to be recorded in the final sector when recording is performed in TDMA 17; and when management information is newly recorded, the position information on the corresponding management information retained in the TDDS is also required to be changed. Therefore, when at least one of the TDFL update flag and the SRRI update flan is 1, the TDDS is determined to be management information which necessarily needs to be recorded.

In step 1003, the management information recording section 754 generates, in the buffer 740, a content corresponding to the TDMS Update Unit of M pieces of clusters which is formed only of the'management information selected in step 1002 and the TDDS. When, for example, only the SRRI update flag is 1, a content of the TDMS Update Unit of 1 cluster (M=1) is generated by combining the SRRI updated in step 908 in FIG. 9 and stored in the buffer 740 and the TDDS stored in the buffer 740. Information corresponding to the SRRI position information 607 in the TDDS included in the generated content of the TDMS Update Unit is changed to the position of the cluster in which the SRRI is to be recorded. When only the TDFL update flag is 1, a content of the TDMS Update Unit of M pieces of clusters in total is generated by combining the TDFL updated in step 906 in FIG. 9 and stored in the buffer 740 and the TDDS stored in the buffer 740. Information corresponding to the first TDFL position information 603 through the M′th TDFL position information included in the generated content of the TDMS Update Unit is changed to the position of the clusters in which the respective TDFLs are to be recorded. In the case of the TDFL, the number of generated clusters is varied in accordance with the number of defect entries. In the case where the maximum size of the TDFL is 4 clusters and the size of the TDDS is 1 sector, the total number, M, of clusters of the TDMS Update Unit generated by combining the TDFL and the TDDS is 1≦M≦5.

In step 1004, the management information recording section 754 controls the recording/reproduction section 730 to record the content of TDMS Update Unit generated in step 1003 in the TDMA 17.

In step 1005, the management information recording section 754 determines whether or not the recording of the management information in step 1004 is successful. When it is determined that the recording is unsuccessful, the process goes to step 1008. When it is determined that the recording is successful, the process goes to step 1006.

In step 1006, the management information checking section 755 uses the verification section 753 to perform verification on the management information newly recorded in step 1004, and determines whether or not the management information can be reproduced correctly. When the verification is successful, it is determined that the management information can be reproduced correctly. When the verification is unsuccessful, it is determined that the management information cannot be reproduced correctly. Owing to this, it can be determined whether or not the newly recorded management information is recorded normally.

When it is determined in step 1007 that the management information can be reproduced correctly (verified OK) in step 1006, namely, when the newly recorded management information is recorded normally, the process goes to step 1009. When it is determined that the management information cannot be reproduced correctly in step 1006, namely, when the newly recorded management information is not recorded normally, the process goes to step 1008.

In step 1008, the management information recording section 754 updates the area in which the management information is to be recorded to the next unrecorded area, in order to record, in the next unrecorded area, the management information for which the recording or verification is unsuccessful. In addition, since the recording position is changed, the position information on the management information included in the content of the TDMS Update Unit generated and stored in the buffer 740 is changed to the position of the cluster in which the management information is to be recorded.

In step 1009, the management information recording section 754 determines whether or not all the management information which needs to be recorded in the TDMA 17 has been recorded. For example, it is determined whether or not the content for M pieces of clusters generated in step 1003 has been all recorded. When it is determined that all the management information has been recorded, the process goes to step 1010. When it is determined that all the management information has not been recorded, the process goes to step 1004 in order to record, in the next unrecorded area, the rest of the management information which needs to be recorded in the TDMA 17. Then, steps 1004 through 1009 are repeated until all the management information which needs to be reflected in the TDMA 17 is recorded.

In step 1010, the management information checking section 755 specifies the management information which is determined in step 1002 as not needing to be newly recorded, namely, the reused management information, and find the position of the cluster in the TDMA 17 in which such management information is recorded. For example, when the SRRI update flag is 0, the SRRI is specified as the reused management information. Then, the SRRI position information 607 acquired from the TDDS stored in the buffer 740 is set as the position of the cluster in which the management information to be reused is to be recorded. Similarly, when the TDFL update flag is 0, the TDFL is specified as the reused management information. Then, the first through fourth TDFL position information 603, 604, 605 and 606 are acquired from the TDDS stored in the buffer 740. In the case of the TDFL, in the clusters for which none of the first through fourth TDFL position information 603, 604, 605 and 606 is 0, an effective TDFL is recorded. Therefore, the position of the cluster for which the TDFL position information is not 0 is set as the position of the reused management information. Where it is assumed that the latest TDMS is recorded in N pieces of clusters, 1≦M≦N. Thus, the management information, reused at the time of recording the management information in step 1004, is recorded in (N−M) pieces of clusters. Therefore, in step 1010, the positions of the (N−M) pieces of clusters are found.

In step 1010, at the time when the specification of the reused management information based on the update flag is completed, the management flag which is set to 1 in step 1003 or the like, for the reason that the update is necessary, is set to 0 (cleared). Specifically, when, for example, the SRRI update flag is set to 1 in step 1003 for the reason that the SRRI needs to be updated, the SRRI update flag is cleared, namely, set to 0 after the specification of the reused management information is completed in step 1010.

In step 1011, the management information checking section 755 uses the verification section 753 to perform verification on the reused management information found in step 1010, and determines whether or not the management information can be reproduced correctly. When the verification is successful, it is determined that the management information can be reproduced correctly. When the verification is unsuccessful, it is determined that the management information cannot be reproduced correctly. Owing to this, it can be determined whether or not the reused recorded management information can be recorded normally. Namely, in combination with the verification performed in step 1006, it is checked whether or not all the latest TDMS's recorded in the TDMA can be reproduced correctly.

When it is determined in step 1012 that the management information can be reproduced correctly in step 1011, the process goes to step 1013. When it is determined that the management information cannot be reproduced correctly in step 1011, the process is repeated from step 1002 in order to record the reused management information in the TDMA 17 again. Before the process is repeated, the management information to be reused is set to management information which needs to be recorded (for example, in the case where the management information is the SRRI, the SRRI update flag is set to 1).

In step 1013, the management information checking section 755 determines whether or not verification has been performed on all the reused management information. For example, it is determined whether or not verification has been performed on all the (N−M) pieces of clusters specified in step 1010. When it is determined that verification has been performed on all the management information, the process is finished. When it is determined that verification has not been performed on all the management information, the process returns to step 1011 in order to perform verification on the rest of the reused management information.

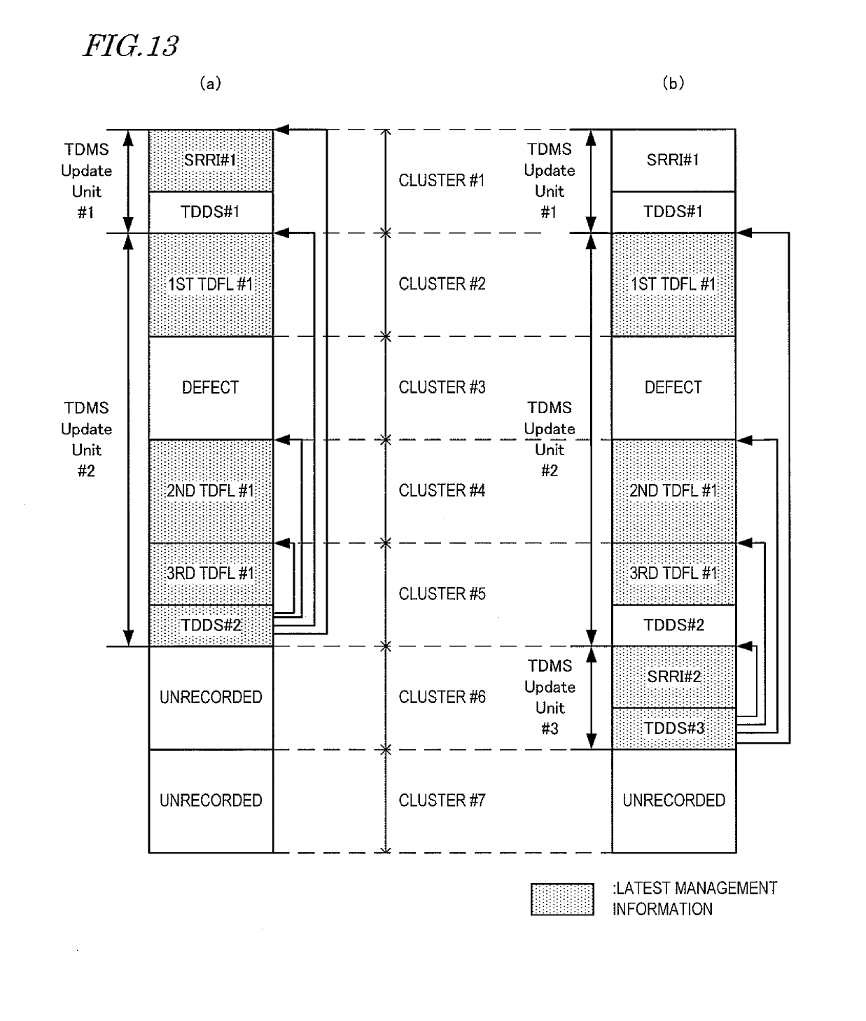

A flow of process of recording the management information in the TDMA in Embodiment 1 according to the present invention which is shown in FIG. 10 will be specifically described with reference to FIG. 11.

FIG. 11 shows a state of the TDMA 17 after the management information is recorded from the state shown in FIG. 13(b) by the method of recording the management information shown in FIG. 10. In the case where the SRRI update flag is 1. It is assumed that the SRRI update flag is 1 and the TDFL update flag is 0 in order to update the SRRI. Also, the following situation is assumed. At the time of recording SRRI #3 and TDDS #4 in cluster #7, track jump occurs unintentionally. As a result, the recording in cluster #7 is unsuccessful. In addition, data already recorded in cluster #5 is overwritten and destroyed.

In step 1001, the border between cluster #6 and cluster #7 is detected as the border position between the recorded area and the unrecorded area, and cluster #7 is set as the position of a leading end of the unrecorded area of the TDMA. Namely, new management information is recorded from cluster #7.

The SRRI update flag is 1. Therefore, in step 1002, it is determined that the management information which needs to be reflected in the TDMA 17 is the SRRI.

In step 1003, the content of TDMS Update Unit #4 (M=1) formed of SRRI #3 and TDDS #4 is generated and stored in the buffer 740. In this process, information corresponding to the SRRI position information 607 included in the content of TDDS #4 is changed to cluster #7 in which the SRRI is to be recorded.

In step 1004, the content of TDMS Update Unit #4 generated and stored in the buffer 740 is recorded in cluster #7.

While the information is recorded in cluster #7, track jump occurs, and the data in cluster #5 is destroyed.

In step 1005, since the recording is unsuccessful in step 1004, the process goes to step 1008.

In step 1008, the position of the cluster in which the content of TDMS Update Unit #4 is to be recorded is found again, and the position information is updated to cluster #8. Namely, the information corresponding to the SRRI position information included in TDDS #4 in the buffer 740 is changed to cluster #8 in which the SRRI is to be newly recorded.

In step 1009, since the recording of the management information which needs to be recorded in the TDMA 17 has not been completed, the process returns to step 1004.

In steps 1004 through 1009, the content of TDMS Update Unit #4 is recorded in cluster #8.

Since the recording of TDMS Update Unit #4, which is management information which needs to be recorded in the TDMA 17 is finished, the process goes to step 1010. Since the TDFL update flag is 0, the TDFL is specified as the reused management information, and four pieces of TDFL position information, namely, the first TDFL position information 603 through the fourth TDFL position information 606, are acquired from TDDS #4 stored in the buffer 740. In the case of FIG. 11, cluster #2 is acquired as the first TDFL position information 603, cluster #4 is acquired as the second TDFL position information 604, cluster #5 is acquired as the third TDFL position information 605, and 0 is acquired as the fourth TDFL position information 606. Therefore, cluster #2, cluster #4 and cluster #5 are specified as the clusters in which the reused management information is recorded. In the case of FIG. 11, since the latest TDMS is formed of three clusters of the TDFL, the SRRI and one cluster of the TDDS, N=4. The management information to be recorded is in one cluster which is a combination of the SRRI and the TDDS; namely, M=1. Therefore, the management information to be reused is in three clusters of the TDFL; namely, N−M=4−1=3 clusters.

In step 1101, verification is performed on cluster #2. Since it is determined in step 1012 that the verification is successful, the process goes to step 1013.

Since it is determined in step 1013 that verification has not been performed on cluster #4 or cluster #5, the process returns to step 1011, where verification is performed on cluster #4. Since it is determined in step 1012 that the verification on cluster #4 is successful, the process goes to step 1013.

Since it is determined in step 1013 that verification has not been performed on cluster #5, the process goes to step 1011, where verification is performed on cluster #5. Since the data in cluster #5 cannot be reproduced correctly, it is determined in step 1012 that the verification is unsuccessful. In order to record the TDFL, which is the management information to be reused, in the TDMA 17 again, steps 1002 through 1009 are repeated after the TDFL update flag is set to 1. Owing to this, the TDFL is set as the management information which needs to be recorded in the TDMA, and the management information including third TDFL #1 (TDMS Update Unit #5), for which the verification is unsuccessful, is recorded in the TDMA 17 and verification is performed thereon.

Since TDMS Update Unit # is newly recorded in the TDMA 17, SRRI #3 is set as the reused management information. Steps 1010 and 1011 are executed to perform verification on cluster #8 in which SRRI #3 is recorded.

Since it is determined in step 1012 that the verification on cluster #8 is successful, the process goes to step 1013.

Since it is determined in step 1013 that verification has been performed on all the management information to be reused, the process is finished.

As described above, by the method of recording management information in the TDMA in Embodiment 1 according to the present invention, when management information which needs to be recorded is recorded, verification is performed on all the clusters which form the latest management information (latest TDMS) including the reused management information, and it is checked whether or not the management information can be reproduced correctly.

Namely, according to a recording/reproduction method in Embodiment 1, the following operations are executed.

According to a recording/reproduction method in Embodiment 1, step (a) of recording or reproducing data on or from an information recording medium, and step (b) of reproducing the data recorded on the information recording medium and checking whether or not the data can be reproduced normally, are executed. Also, step (c) of recording, on the information recording medium, only management information which needs to be changed among a plurality of types of management information for managing the data recorded on the information recording medium (e.g., TDFL, SRRI, SBM, TDDS) is executed. Then, step (d) of checking whether or not latest management information including management information which is determined as not needing to be changed and is to be reused can be reproduced normally is executed.

In the case where the latest management information is recorded on the information recording medium discontinuously and management information different from the latest management information is recorded between positions at which the latest management information is recorded, the management information different from the latest management information may not be reproduced in step (d). Herein, the expression “the latest management information is recorded on the information recording medium discontinuously” indicates a state where as seen in units of clusters, which is a recording/reproduction unit of the information recording medium, the clusters in which the latest management information is recorded are discrete (discontinuous). The expression “management information different from the latest management information is recorded between positions at which the latest management information is recorded” indicates a state where the management information which is not latest is recorded in a cluster located between discontinuous (discrete) clusters in which the latest management information is recorded.

In the case where it is confirmed that the latest management information cannot be reproduced normally, the management information which is not reproduced normally among at least the latest management information may be re-recorded.

At least one of the plurality of types of management information (e.g., TDDS) includes management information position information which indicates a position at which the other types of management information (e.g., TDFL, SRRI, SBM) are recorded. In step (d), a position at which the management information to be reused is recorded may be specified based on the management information position information.

As mainly described in Embodiment 1, the plurality of types of management information may be defect management information for managing a defective area of the information recording medium (e.g., TDFL), recording management information indicating a recording state of the information recording medium (e.g., SRRI or SBM), and a disc definition structure indicating a structure of the information recording medium (e.g., TDDS). The disc definition structure may include defect management information position information indicating a position at which the defect management information is recorded, and recording management information position information indicating a position at which the recording management information is recorded. In step (d), a position at which the management information to be reused is recorded may be specified based on the defect management information position information and the recording management information position information.

A recording/reproduction device in Embodiment 1 has the following structure.

A recording/reproduction device in Embodiment 1 includes a recording/reproduction section 730 for recording or reproducing data on or from an information recording medium; a verification section 753 for reproducing the data recorded on the information recording medium by use of the recording/reproduction section and checking whether or not the data can be reproduced normally; a management information recording section 754 for recording, on the information recording medium by use of the recording/reproduction section, only management information which needs to be changed among a plurality of types of management information for managing the data recorded on the information recording medium (e.g., TDFL, SRRI, SBM, TDDS); and a management information checking section 755 for checking, by use of the verification section, whether or not latest management information including management information which is determined as not needing to be changed and is to be reused can be reproduced normally.

In the case where the latest management information is recorded on the information recording medium discontinuously and management information different from the latest management information is recorded between positions at which the latest management information is recorded, the management information checking section may not reproduce the management information different from the latest management information at the time of checking the latest management information.

In the case where the management information checking section confirms that the latest management information cannot be reproduced normally, the recording/reproduction section may re-record the management information which is not reproduced normally among at least the latest management information.

At least one of the plurality of types of management information (e.g., TDDS) includes management information position information which indicates a position at which the other types of management information (e.g., TDFL, SRRI, SBM) are recorded. The management information checking section may specify a position at which the management information to be reused is recorded, based on the management information position information.

As mainly described in Embodiment 1, the plurality of types of management information may be defect management information for managing a defective area of the information recording medium (e.g., TDFL), recording management information indicating a recording state of the information recording medium (e.g., SRRI or SBM), and a disc definition structure indicating a structure of the information recording medium (e.g., TDDS). The disc definition structure may include defect management information position information indicating a position at which the defect management information is recorded, and recording management information position information indicating a position at which the recording management information is recorded. The management information checking section may specify a position at which the management information to be reused is recorded, based on the defect management information position information and the recording management information position information.

According to the information recording/reproduction method and the structure of the information recording/reproduction device in Embodiment 1 according to the present invention, confirmation (verification) is performed on all the latest management information after the recording. Therefore, it can be guaranteed that the latest management information can be reproduced correctly. For example, in the case of FIG. 11, even if data is unintentionally destroyed due to track jump during the recording, it can be detected that the data in cluster #5 which is destroyed cannot be reproduced correctly (it can be detected that data in cluster #5 is destroyed). The content of the TDFL retained in the buffer 740 is recorded in the TDMA 17 again instead of in the destroyed TDFL. Thus, the TDFL 400 including third TDFL #1 which can be reproduced correctly is recorded in the TDMA 17. Therefore, it can be guaranteed that all the latest TDMS's can be reproduced correctly.

Namely, even if the latest management information (latest TDMS) is destroyed during the recording, it can be detected correctly that the latest management information cannot be reproduced. In addition, the management information which cannot be reproduced is re-recorded in the TDMA by use of the latest management information stored (cached) in the buffer. Therefore, it is guaranteed that all the latest management information recorded in the TDMA 17 can be reproduced correctly.

When this technique is applied, substantially the same effect is provided when the latest management information cannot be reproduced due to a scratch, dust or a stain such as fingerprint or the like attached after the latest management information is recorded.

In Embodiment 1 according to the present invention, after the positions at which the elements of the latest management information are recorded are specified, the latest management information is reproduced. Therefore, the area for verification can be minimized to only the necessary area, and the time required for verification can be minimized. Thus, it can be determined at higher speed whether or not the management information can be reproduced correctly. In addition, even if there is a defective cluster between areas where the latest management information is recorded, reproduction is not performed from the area of the defective cluster. Thus, it can be determined at higher speed whether or not the management information can be reproduced correctly. Even if the latest management information is recorded discontinuously (discretely) and there is non-latest management information between areas where the latest management information is recorded, reproduction is not performed from the area where the non-latest management information is recorded. Thus, it can be determined at higher speed whether or not the management information can be reproduced correctly.

It is not necessary to reproduce and retain all the data of a prescribed area range before recording is performed. Therefore, the expansion of the buffer is minimized, and thus it can be determined at higher speed and at the minimum cost whether or not the recorded management information can be reproduced correctly.

In step 1013, verification is performed on the clusters one by one. In the case where the areas for which verification is to be performed are continuous as cluster #4 and cluster #5 in FIG. 11, verification may be performed on such a plurality of clusters at a time. This makes it unnecessary to perform a seek operation at the start of the verification on cluster #5, and the verification can be performed at higher speed.

In Embodiment 1 according to the present invention, each time the management information which needs to be recorded in the TDMA 17 is recorded, verification is performed on the management information to be reused. The verification merely needs to be performed before the information recording medium 100 is removed (ejected) from the information recording/reproduction device 700 so that a state where the management information is reproduced correctly is provided. Therefore, the timing of performing the verification is not limited to the above.

For, example, in order to shorten the time duration required for recording the management information, the number of times of recording in the TDMA 17 may be counted, so that verification is performed on the reused management information when the number of times reaches a prescribed value. Alternatively, information on the time at which the recording is performed in the TDMA 17 may be retained, so that verification is performed on the reused management information, using the elapse of a prescribed time duration from such time as a trigger. Still alternatively, verification may be performed on the management information to be reused during the time when recording or reproduction is not performed by the information recording/reproduction device 700 on the information recording medium 100.

For example, only when a recording error is detected at the time of recording of new management information, verification may be performed on the reused management information. Alternatively, only when a recording error having a high possibility of destroying data due to track jump (e.g., abnormal track error signal, position information at which recording stops being offset, synchronization offset of disc rotation, etc.) occurs, verification may be performed on the management information to be reused. Owing to this, the number of times verification is performed on the management information to be reused can be decreased, and thus the performance can be further improved.

For example, track jump may be detected by use of a tracking error signal, so that verification is performed on the management information to be reused only when it is confirmed that the head has jumped to a recorded track. Owing to this, the number of times verification is performed on the management information to be reused can be decreased, and thus the performance can be further improved. By contrast, when the head has jumped to an unrecorded track, there is no destroyed data at this point. The information recording medium 100 is a write-once, read-many medium. Therefore, when it is attempted to record data in a destroyed area, recording or verification is unsuccessful. As a result, the data attempted to be recorded is re-recorded in another area. For this reason, when the head jumps to an unrecorded track, verification on the management information to be reused does not need to be performed. When track jump occurs, whether the head has jumped to a recorded area or to an unrecorded area can be determined, for example, by following physical address information read from the information recording medium 100 (in the case of a BD, physical address information embedded in the information recording medium 100, such as ADIP or the like) or based on the amplitude of an RF signal.

Namely, in the case where recording of the management information which needs to be changed is successful with a retry, step (d) may be executed. In the case where recording of the management information which needs to be changed is successful with no retry, step (e) of checking whether or not the latest management information other than the management information to be reused (i.e., management information which needed to be changed and thus was recorded) can be reproduced correctly may be executed.

According to the recording/reproduction device in Embodiment 1, in the case where recording of the management information which needs to be changed is successful with a retry, the management information checking section may check whether or not the latest management information including the management information to be reused can be reproduced normally. In the case where recording of the management information which needs to be changed is successful with no retry, the management information checking section may check whether or not the recorded management information which needed to be changed can be reproduced normally, but may not check whether or not the management information to be reused can be reproduced normally.

The recording/reproduction device in Embodiment 1 may further include a second management information checking section for checking, by use of the verification section, whether or not the latest management information other than the management information to be reused (i.e., only the management information which needed to be changed and thus was recorded) can be reproduced correctly. In the case where the management information recording section succeeds in the recording with a retry, the management information checking section may perform the checking operation; whereas in the case where the management information recording section succeeds in the recording with no retry, the second management information checking section may perform the checking operation.

Owing to the above-described structure, the number of times verification is performed on the management information to be reused can be decreased, and thus the performance can be further improved.

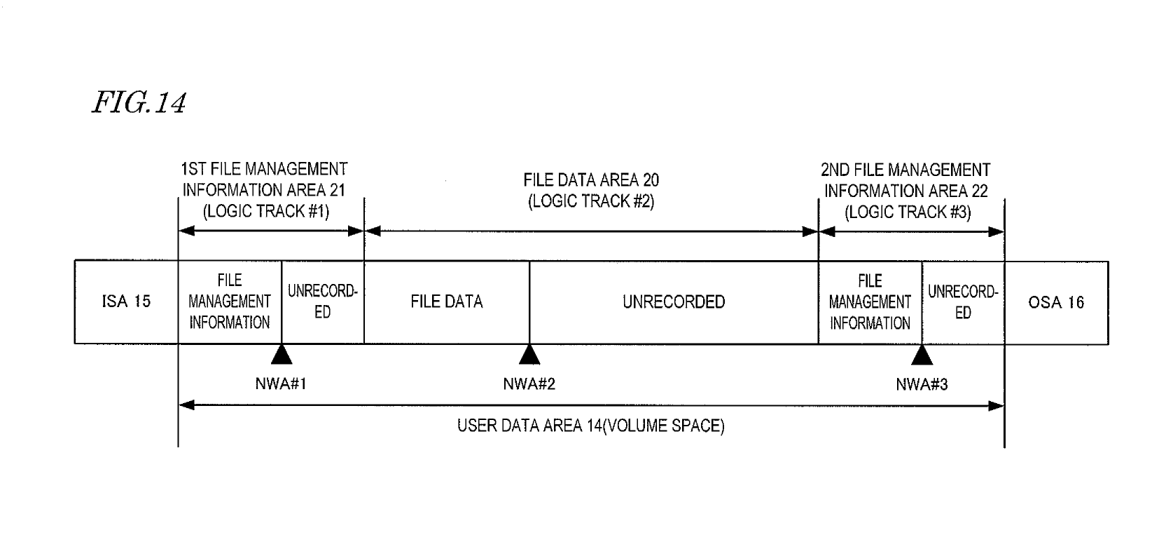

In Embodiment 1 according to the present invention, for specifying management information which needs to be recorded in the TDMA 17, a TDFL update flag and an SRRI update flag which indicate the type of the updated management information are used. In the case where, for example, the TDFL 400 is formed of three clusters, when the defect entry 402 (data corresponding to the defect entry 402) is added to the TDFL, data of three clusters is recorded in the TDMA 17. However, while sequential recording is performed, a defect entry, if added to the TDFL, is often added to the position of the final data of the TDFL, namely, to the third TDFL, and the number of defect entries in the DFL header included in the first TDFL is updated. Namely, the first TDFL (the number of defect entries in the DFL header included in the first TDFL) and the third TDFL are changed, whereas the second TDFL is not changed. In this case, the management information which needs to be reflected is information of only two clusters including the first TDFL and the third TDFL in the TDFL. Alternatively, in FIG. 11, verification is unsuccessful only on cluster #5. Therefore, the management information which needs to be reflected in the TDMA again is information of only one cluster including the third TDFL in the TDFL. Thus, for example, update flag information may be stored in the buffer 740 and used as a first TDFL update flag, a second TDFL update flag, a third TDFL update flag, a fourth TDFL update flag and the SRRI update flag which indicate the elements of the updated management information, like the management information being stored in units of clusters. FIG. 12 shows how information is actually recorded in the TDMA 17 by this method.

FIG. 12(a) shows a state of the TDMA 17 after the TDFL 400 is recorded in an updated manner by a method of recording management information in the TDMA 17 shown in FIG. 10 by use of update flags indicating the elements of the management information which is updated from the state shown in FIG. 13(a). The TDFL 400 is recorded in an updated manner in the TDMA 17 because a defect entry is newly added.

When a defect entry is added to the TDFL, only the first TDFL and the third TDFL are changed as described above. Therefore, the first TDFL update flag and the third TDFL update flag are set to 1, and the second TDFL update flag, the fourth TDFL update flag and the SRRI update flag are set to 0. Owing to this, in step 1002, the first TDFL, the third TDFL and the TDDS are specified as the management information which needs to be reflected in the TDMA.

By executing steps 1003 through 1009, as shown in FIG. 12(a), two clusters in TDMS Update Unit #3 formed of first TDFL #2, third TDFL #2 and TDDS #3 are recorded in the TDMA.

The second TDFL update flag and the fourth TDFL update flag are 0. As the second TDFL position information 604, the position of cluster #4 is acquired; as the fourth TDFL position information 606, 0 (indicating that there is no corresponding cluster) is acquired; and as the SRRI position information 607, the position of cluster #5 is acquired. Therefore, in step 1010, the second TDFL and the SRRI are specified as the reused management information.

By executing steps 1011 through 1013, verification is performed on cluster #1 and cluster #4.

Owing to this, the management information which needs to be recorded can be recorded in the TDMA 17 while the consumption of the TDMA 17 is further suppressed.

FIG. 12(b) shows a state of the TDMA after recording is performed in the TDMA 17 by a method of recording only a content, which is a combination of the information in the cluster for which the verification is unsuccessful in FIG. 11 (i.e., third TDFL) and the TDDS, as TDMS Update Unit by use of update flags indicating the elements of the updated management information.

In the case of FIG. 11, the TDFL update flag is set to 1 when verification on cluster #5 is unsuccessful. In the case of FIG. 12(b), only the third TDFL update flag, which is the update flag of the third TDFL included in cluster #5 for which the verification is unsuccessful is set to 1, whereas the other update flags are set to 0. Owing to this, in step 1002, the third TDFL and the TDDS are specified as the management information which needs to be reflected in the TDMA.

By executing steps 1003 through 1009, as shown in FIG. 12(b), one cluster of TDMS Update Unit #4 formed of third TDFL #1 and TDDS #5 are recorded in the TDMA 17.

The first TDFL update flag, the second TDFL update flag, the fourth TDFL update flag and the SRRI update flag are 0. As the first TDFL position information 603, the position of cluster #2 is acquired; as the second TDFL position information 604, the position of cluster #4 is acquired; as the fourth TDFL position information 606, 0 (indicating that there is no corresponding cluster) is acquired; and as the SRRI position information 607, the position of cluster #8 is acquired. Therefore, in step 1010, the first TDFL, the second TDFL and the SRRI are specified as the management information to be reused.

By executing steps 1011 through 1013, verification is performed on cluster #2, cluster #4 and cluster #8.

By use of such a method, when verification on the management information to be reused is unsuccessful, the management information can be re-recorded in the TDMA while the consumption of the TDMA 17 is further suppressed.

In FIG. 11, the update flags indicating the types of the updated management information (TDFL update flag, SRRI update flag) are used. In FIG. 12, the update flags indicating the elements of the updated management information (first TDFL update flag, second TDFL update flag, third TDFL update flag, fourth TDFL update flag, SRRI update flag) are used. The updated flags to be used are not limited to these as long as the management information which needs to be reflected in the TDMA 17 is identified.

As shown in FIG. 12(a), in the case where the management information is to be recorded in a plurality of clusters in the TDMA 17 and is recorded in these clusters one by one, after the management information is recorded in cluster #6, the head needs to perform a seek operation before recording the management information in cluster #7. Namely, the recording in cluster #6 and the recording in cluster #7 are discontinuous. Thus, there is an undesirable possibility that data in cluster #6 may be overwritten and destroyed at the time of recording data in cluster #7. Therefore, when performing verification on the management information to be reused, verification may also be performed on cluster #6. Owing to this, even if the data in cluster #6 is destroyed at the time of recording data in cluster #7, it can be detected that the data cannot be reproduced correctly from cluster #6.

Alternatively, verification may be performed on a plurality of clusters at a time after recording is performed on the plurality of clusters at a time. This makes it unnecessary to perform a seek operation before the recording is performed in each cluster. As compared with the case where the recording is performed in the clusters one by one, the management information can be recorded at higher speed.

In Embodiment 1 according to the present invention, after the management information which needs to be recorded in the TDMA 17 is recorded, verification is performed on the newly recorded management information, and then verification is performed on the management information to be reused. Verification merely needs to be performed on all the elements of the latest management information, and the order of verification is not limited to the above. For example, verification may be performed as follows. After the management information which needs to be recorded in the TDMA is recorded, the position information on all the latest management information included in the TDDS is acquired. Verification is performed on the newly recorded management information and the reused management information in the order from the information corresponding to a smaller value of the position information (the order along the track). According to this method, verification is performed in the order along the track, and thus the time required for the seek operation can be shortened. Therefore, it can be determined at higher speed whether or not the management information can be reproduced correctly. In addition, it is not necessary to distinguish the newly recorded management information from the management information to be reused. Therefore, step 1010 or the like is not necessary, and verification on the latest management information can be performed more simply.

In Embodiment 1 according to the present invention, the information recording medium 100 is a BD-R, which is a write-once read-many medium, of a single-layer type. Alternatively, a multi-layer disc including a plurality of recording layers may be used. The recording mode may be a random mode instead of the sequential mode.

The information recording medium 100 may be a rewritable medium such as a BD-RE instead of the write-once read-many medium. The management information of the BD-RE includes a DDS and a DFL; namely, the DMA does not include the SRRI unlike the DMA shown in FIG. 3. In the case of a rewritable medium, when a defect entry is added, the DFL included in the DMAs is overwritten. Therefore, the DFL position information included in the DDS is not changed, and thus the DDS is not recorded in this case. Verification is performed in the state where only the DFL is specified as the management information which needs to be recorded and the DDS is specified as the management information to be reused. In this manner, Embodiment 1 according to the present invention is applicable to a rewritable disc.

### Embodiment 2

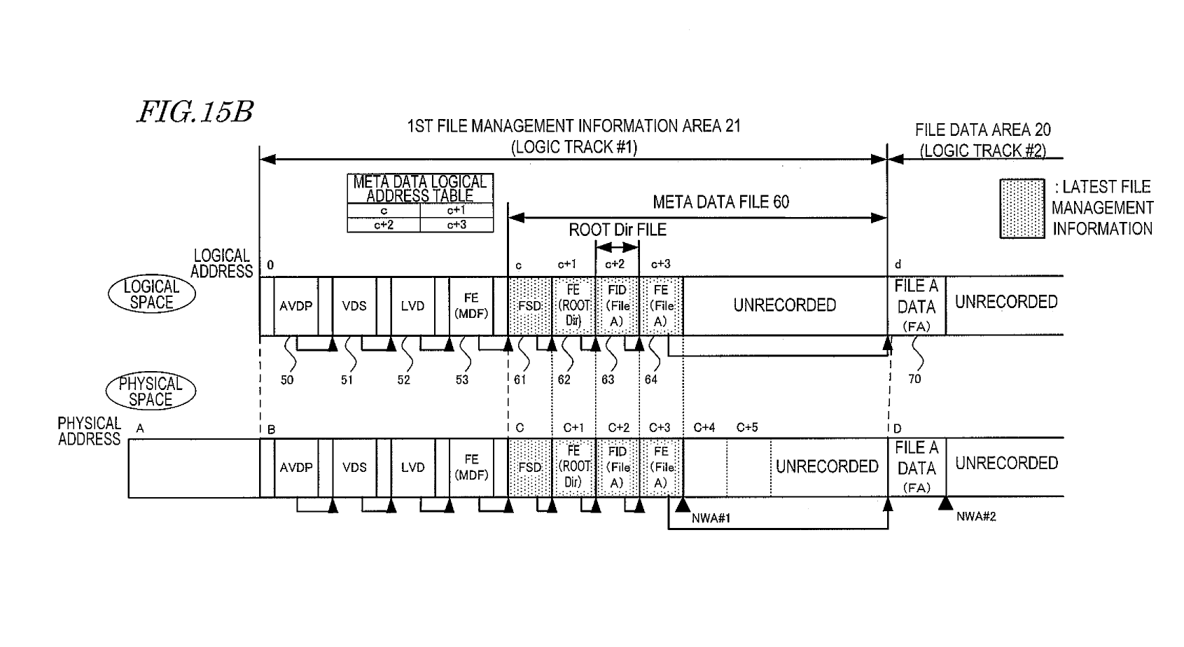

FIG. 14 shows a structure of the data zone 5 in Embodiment 2 according to the present invention. In the following description, an information recording medium in Embodiment 2 according to the present invention is the information recording medium 100 shown in FIG. 2, which is a BD-R, i.e., a write-once read-many medium on which recording can be performed only once.

As shown in FIG. 2, the data zone 5 includes the user data area 14 on which user data is to be recorded, and the ISA 15 and the OSA 16, which are spare areas prepared for replacement recording.

The user data area 14 is also called a “volume space”, and includes a file data area 20 in which a file as the user data is to be recorded, and file management information areas in which file management information for managing the file is to be recorded (first file management information area 21 and second file management information area 22).

In FIG. 14, two file management information areas are provided; namely, one is provided before the file data area 20 and the other is provided after the file data area 20. The first file management information area 21 and the second file management information area 22 are provided for recording the file management information in an overlapping manner, and thus improve the robustness of the file management information. This positioning arrangement is merely an example, and the number and the positions of the file management information areas are not limited to these.

In Embodiment 2 according to the present invention, the file recorded in the file data area 20 is managed by a file system. In the following description, UDF (Universal Disc Format) is used as the file system. The file management information has a data structure defined by the ISO/IEC13346 format or the UDF format.

The user data area 14 can be divided into logic tracks so that a plurality of write-once positions are provided. The “logic track” is a management unit for sequential recording, and is so called in order to be distinguished from the track 2 provided as a groove in the disc. On the logic track, sequential recording is performed from a leading end toward a trailing end, and the start position of the next recording (write-once) of each logic track is managed by NWA (Next Writable Address).

In Embodiment 2 according to the present invention, the user data area 20 is divided into three logic tracks. Logic track #1 is assigned as the first file management information area 21, logic track #3 is assigned as the second file management information area 22, and logic track #2 is assigned as the file data area 20 in which the file data is to be recorded. In the following description, the first file management information area 21 will be described as an example of file management information area.

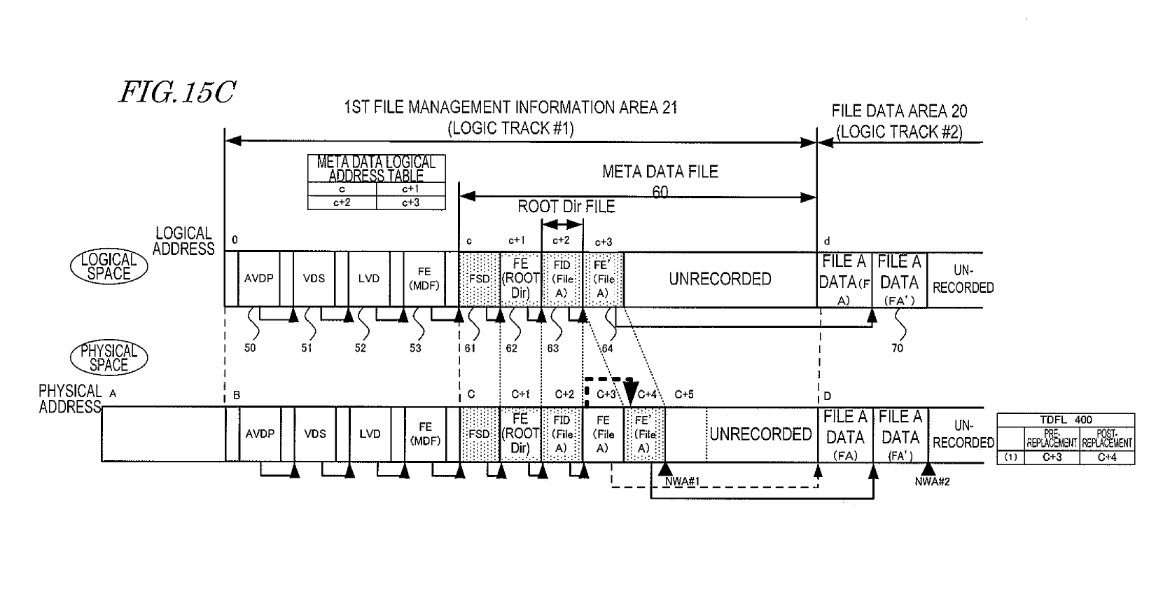

FIG. 15A shows a directory structure included in the information recording medium 100 in Embodiment 2 according to the present invention. The information recording medium 100 in Embodiment 2 according to the present invention includes a root directory (root Dir) as a basic directory, and the root directory has only one file, namely, file A.

FIG. 15B shows a data structure of the user data area 14 in which file data of the directory structure shown in FIG. 15A is recorded.

In the first file management information area 21, plurality of types of file management information are recorded in order to manage files.

The file management information includes an ADVP 50, a VDS 51, an LVD 52, an FE (MDF) 53 regarding meta data file 60, and a meta data file 60. Substantive data in the file is managed by such management information.

The ADVP (Anchor Volume Descriptor Pointer) 50 is information which is recorded at a prescribed position (e.g., sector position having a logical sector number (LSN) of 256) and acts as a starting point of the file system. From the ADVP 50, all the files on the information recording medium 100 can be reached. The ADVP 50 includes information on a position at which the VDS (Volume Descriptor Sequence) 51 is recorded.

The VDS 51 has information regarding a volume recorded on the information recording medium 100, and includes information on a position at which the LVD 52 (Logical Volume Descriptor) is recorded.

The LVD 52 has information regarding a logical volume, and includes information on a position at which the FE (MDF) 53, which is an FE (File Entry) regarding the meta data file 60, is recorded.

The FE is information for managing each directory and file, and includes information on a position at which each file is recorded and the size of the file.

At a leading end of the meta data file 60, an FDS (File Set Descriptor) 61 is recorded. Therefore, the FE (MDF) 53, which is an FE regarding the meta data file, includes information on a position at which the FSD 61 is recorded.

The meta data file 60 includes the FSD 61 and other information on the file structure. The meta data file 60 includes an FE regarding each file, data of each directory and file, and the like.

The FSD 61 includes information on a position at which an FE (root Dir) 62, which is an FE regarding the root directory, is recorded.

In each directory, files included in the directory and an FID (File Identifier Descriptor) of the directory are recorded.

The FID includes information on a position at which the FE of each file or directory is recorded, and a file type which indicates whether the data managed by the FID is a file or a directory. The information recording medium 100 in Embodiment 2 according to the present invention is assumed to include only the root directory as a directory and only File A as a file for the sake of simplicity. As a result, the recording/reproduction device 100 includes only one FID, namely, the FID (File A) regarding File A.

In the file data area 20, substantive data of the file (in Embodiment 2 according to the present invention, only File A data (FA) 70, which is the substantive data of File A) is recorded. In the FE corresponding to each file (only an FE (File A) 64, which is the FE regarding File A), information on a position at which the substantive data of the file is recorded.

Namely, an example of operation of reading substantive data of a file, i.e., an operation of reading File A from the information recording medium 100 shown in FIG. 15B is as follows.

1) Read the ADVP 50 and acquire the position regarding the VDS 51.

2) Read the VDS 51 and acquire the position information regarding the LVD 52.

3) Read the LVD 52 and acquire the position information regarding the FE (MDF) 53.

4) Read the FE (MDF) 53 and acquire the position information regarding a leading end of the meta data file 60 (position information on the FSD 61).

5) Read the FSD 61 and acquire the position information on the FE (root Dir) 62, which is an FE regarding the root directory.

6) Read the FE (root Dir) 62 and acquire the position information on the FID (File A) 63, which is an FID of File A.

7) Read the FID (File A) 63 and acquire the position information on the FE (File A) 64, which is an FE regarding File A.

8) Read the FE (File A) 64 and acquire the position information on the File A data 70.

9) Read the File A data (FA) 70.

Now, a logical address and a physical address will be described. The logical address is an address assigned to the user data area 14 continuously with the leading end thereof being 0. The file system controls recording/reproduction operations or the like performed on the information recording medium 100 by use of the logical address. By contrast, the physical address is an address of a physical position on the information recording medium 100 and is, for example, embedded in the information recording medium 100. In the case of, for example, a BD, the physical address corresponds to the ADIP described above. A device for accessing the information recording medium 100 (e.g., optical disc drive device) converts a logical address into a physical address, and controls recording/reproduction operations or the like performed on the information recording medium 100 by use of the physical address. One logical address necessarily corresponds to one physical address. Namely, when, for example, a defective area is replaced with another area, the physical address which corresponds to the logical address and is assigned to the defective area is changed to a physical address of a post-replacement area.

FIG. 15B shows a logical space managed by the logical address and a physical space managed by the physical address in comparison.

As shown in FIG. 15B, it is assumed that the logical addresses at which the meta data file is recorded (i.e., metal data logical address table in the figure) are as follows: the FSD 61 is “c”, the FE (root Dir) 62 is “c+1”, the FID (File A) 63 is “c+2”, and the FE (File A) 64 is “c+3”. The respective physical addresses are as follows: the FSD 61 is “C”, the FE (root Dir) 62 is “C+1”, the FID (File A) 63 is “C+2”, and the FE (File A) 64 is “C+3”.

FIG. 15C shows a data structure of the user data area 14 in the state where File A included in the information recording medium 100 shown in FIG. 15B is updated (changed).

As described in Embodiment 1 according to the present invention, a BD-R has a logical overwriting (LOW) function. On the write-once read-many information recording medium 100, recorded data cannot be physically overwritten to be changed. According to the logical overwriting function, a defect management function, namely, a replacement recording function, of the BD-R is used to record the data which needs to be recorded in a replacing manner, so that the original data logically appears to be rewritten with another data. More specifically, data, which is to be recorded in an area of the same logical address as the original data, is recorded in an area of a different physical address in a replacing manner. In this case, an area of the user data area 14, in which the original data is also recorded, is assigned to a post-replacement recording area. Usually, a cluster at the NWA position of the same logic track as the track of the pre-replacement area is assigned as a post-replacement recording area. When the recording in such an area is unsuccessful, the data is recorded in, for example, the ISA 15 as a spare area by use of the usual defect replacement recording function. The above-described operation can be summarized as follows. When a request to overwrite data in an optional logical address is issued, a physical address indicating an unrecorded area of the information recording medium 100 is re-assigned to the logical address, and the data is recorded in an area of the re-assigned physical address. Information regarding the reassignment of the physical address is retained as defect management information. After this, when a request to reproduce the data from the logical address is issued, the data is reproduced from the area (area indicated by the re-assigned physical address). Accordingly, although the information recording medium 100 allows data to be recorded only once physically, the data can be rewritten logically. This function is mainly used for recording management information such as a file system or the like.

As shown in FIG. 15C, the File A data (FA) 70, which is substantive data of File A, is recorded in an updated manner as File A data (FA′) in the physical space. Namely, the substantive data of File A becomes File A data (FA') 70. Since the recording position and the size of File A are changed, the content of the FE (File A) 64 in the meta data file 60 including such information is also changed. The FE (File A) 64 is logically overwritten and updated by the LOW function. As a result, the FE (File A) 64 is changed to FE′ (File A) 64. The physical address “C+3” originally recorded in correspondence with the logical address “c+3” is changed to “C+4”. In the TDFL 400, the defect entry 402 indicating a pre-replacement cluster of “C+3” and a post-replacement cluster of “C+4” is registered. After this, when a request to access the logical address “c+3” is issued from the file system, the access is made to the physical address “C+4”. In this manner, when replacement recording is performed, the correspondence between the logical address and the physical address is changed after the replacement recording.

In the above example, File A which is already recorded is updated. When a file or directory is newly added also, the meta data file 60 is used as the management information, for the file system, which is rewritten (changed).

Now, a case will be discussed where when management information is rewritten because of addition or change of a file or directory, unintentional track jump occurs, as in Embodiment 1 according to the present invention.

In this case, it may be possible to perform verification on all the recorded areas in the first file management information area 21 in which the management information for the file system is recorded, in order to determine whether or not data has been destroyed due to the track jump. However, as compared with the TDMS in Embodiment 1 according to the present invention, the data amount of the file management information is significantly larger. Therefore, it is more efficient to perform verification only on the latest file management information as in Embodiment 1 according to the present invention.

Thus, when performing verification on the latest file management information regarding the meta data file 60, verification merely needs to be performed on the area where the latest file management information is recorded as shown in the meta data logical address table in FIG. 15B.

For example, when the FE′ (File A) 64 is newly recorded as shown in FIG. 15C, verification does not need to be performed on the position of the physical address “C+3” at which the FE (File A) 64 was recorded previously. Verification merely needs to be performed on the position of the physical address “C+4”, which is the position of the newly recorded FE′ (File A) 64 and on the positions of the physical addresses “C”, “C+1” and “C+2” at which the FSD 61, the FE (root Dir) 62 and the FID (File A) 63 are recorded. If a destroyed area for which verification is unsuccessful is found, the data in such an area is recorded in a spare area (e.g., the ISA 15) by defective replacement recording. Thus, the data can be restored.

Even if replacement recording is performed and the physical address at which the information is recorded is changed, the latest file management information can be read to check whether or not the latest file management information can be reproduced correctly as follows. Data in the logical space is read in accordance with the procedure described above from the AVDP 50 along the logical addresses by use of the position information (pointer information) of the related information included the respective management information.

However, the management information of the file system, even though only the related management information, is still located in a wide area in the first file management information area 21 or the like.

Regarding track jump which may occur at the time of data recording and may cause a proximate track to be destroyed, the tracks (i.e., the area range) which are actually jumped as a result of the head being derailed is substantially limited to the tracks in the vicinity of the position at which the information is to be recorded.

In other words, the area range for which data destruction due to overwriting is to be checked may also be limited. In this case, the determination needs to be performed by use of the actual address in the information recording medium 100, namely, the physical address. Therefore, the physical position (physical address) of the area (cluster), for which verification on the latest management information is to be performed, can be specified by use of a combination of the position information (pointer information) on the related information included in the respective management information and the defect entry 402 included in the TDFL 400. In this manner, the data destruction due to overwriting can be checked at higher speed and more efficiently as compared with the case where the checking is performed by use of only the logical address. For example, a case will be discussed where the LOW is performed on the meta data file 60 because the information of File A is further changed or a new file is added from the state in FIG. 15C. In this case, there are many areas where the latest management information is not recorded, like the physical address “C+3” in FIG. 15C. In such a case, the latest film management information, which exists in a prescribed range and for which verification needs to be performed in consideration of data destruction after such latest file management information is recorded, is limited at a high possibility. Verification merely needs to be performed on such limited latest file management information. Thus, the checking can be performed more efficiently.

Namely, according to a recording/reproduction method in Embodiment 2, the following operations are executed.

According to a recording/reproduction method in Embodiment 2, step (a) of recording or reproducing data on or from an information recording medium; and step (b) of reproducing the data recorded on the information recording medium and checking whether or not the data can be reproduced normally are executed. Also, step (c) of recording, on the information recording medium, only management information which needs to be changed among a plurality of types of management information for managing the data recorded on the information recording medium (e.g., FSD, FE, FID, etc.) is executed. Then, step (d) of checking whether or not latest management information including management information is determined as not needing to be changed and is to be reused can be reproduced normally is executed.

At least one of the plurality of types of management information may include management information position information which indicates a position at which the other types of management information are recorded; and in step (d), a position at which the management information to be reused is recorded may be specified based on the management information position information.

A recording/reproduction device in Embodiment 2 has the following structure.

A recording/reproduction device in Embodiment 2 includes a recording/reproduction section 730 for recording or reproducing data on or from an information recording medium; a verification section 753 for reproducing the data recorded on the information recording medium by use of the recording/reproduction section and checking whether or not the data can be reproduced normally; a management information recording section 754 for recording, on the information recording medium by use of the recording/reproduction section, only management information which needs to be changed among a plurality of types of management information for managing the data recorded on the information recording medium (e.g., FSD, FE, FID, etc.); and a management information checking section 755 for checking, by use of the verification section, whether or not latest management information including management information which is determined as not needing to be changed and is to be reused can be reproduced normally.

At least one of the plurality of types of management information may include management information position information which indicates a position at which the other types of management information are recorded; and the management information checking section may specify a position at which the management information to be reused is recorded, based on the management information position information.

According to the recording/reproduction method and the structure of the recording/reproduction device in Embodiment 2, as described above, even when management information such as a file system existing in the user data area 14 is recorded, verification is performed on the latest management information which is to be reused or which has not been recorded in an updated manner, so that it can be checked whether or not the necessary management information is destroyed by overwriting. Thus, the reliability of the management information can be improved.

According to the recording/reproduction method in Embodiment 2, in the case where recording of the management information which needs to be changed is successful with a retry, step (d) may be executed; and step (e) of, in the case where recording of the management information which needs to be changed is successful with no retry, checking whether or not the latest management information other than the management information to be reused (i.e., only the management information which needed to be changed, which is a part of the latest management information) can be reproduced normally may be executed.

According to a recording/reproduction device in Embodiment 2, in the case where recording of the management information which needs to be changed is successful with a retry, the management information checking section may check whether or not the latest management information including the management information to be reused can be reproduced normally. In the case where recording of the management information which needs to be changed is successful with no retry, the management information checking section may check whether or not the recorded management information which needed to be changed can be reproduced normally, but may not check whether or not the management information to be reused can be reproduced normally.

The recording/reproduction device in Embodiment 2 may further include a second management information checking section for checking, by use of the verification section, whether or not the latest management information other than the management information to be reused (i.e., only the management information which needed to be changed) can be reproduced correctly. In the case where the management information recording section succeeds in the recording with a retry, the management information checking section may perform the checking operation; whereas in the case where the management information recording section succeeds in the recording with no retry, the second management information checking section may perform the checking operation.

Owing to the above-described structure, the number of times verification is performed on the management information to be reused can be decreased, and thus the performance can be further improved.

In Embodiments 1 and 2 according to the present invention, verification for checking is performed on all the areas corresponding to the latest management information. However, as suggested above in Embodiment 2, it is effective to, for example, perform verification on a limited area range which is possibly destroyed, in consideration of the characteristic of track jump. The number of tracks which are jumped is indefinite. However, the time duration required to detect that track jump occurred is almost the same. Namely, when the number of tracks which are crossed within a unit time is larger, the time duration required to cross each track or each cluster is shorter, and thus the destroyed data amount of each track or each cluster is smaller. By contrast, when the number of tracks which are crossed is smaller, the time duration in which the head stays on one track or one cluster is longer, and thus the destroyed data amount is larger. Based on this, assuming that, for example, data destruction occurs, if the destruction is within a degree which can be corrected in units of clusters, the data may not be necessarily rewritten. Namely, verification may not be performed on data existing at a position distanced from the recording position by a prescribed number of tracks even if the data is the latest management information. This is especially effective when the file management information is recorded in a wider area as in the file system described in Embodiment 2 according to the present invention.

Namely, in step (d) in the recording/reproduction method in Embodiments 1 and 2, the latest management information recorded at a radial position within a prescribed range from the radial position on the information recording medium at which the management information is recorded in step (c) may be treated as the target of the checking.

In the information recording/reproduction device in Embodiments 1 and 2, the management information checking section may set, as the target of checking, the latest management information recorded at a radial position within a prescribed range from the radial position on the information recording medium at which the management information is recorded by the management recording section.

In Embodiments 1 and 2 according to the present invention, verification is performed on the latest management information when the management information such as the TDMS regarding the information recording medium 100 or the file management information such as the file system is recorded. However, the applicable range of the present invention is not limited to the above. Substantially the same effect is provided when the present invention is applicable to data such as latest management information formed of a combination of a plurality of types of information, in which the entirety or a part thereof is recorded (updated) data and the remaining part thereof is data previously recorded and thus reused.

The operation of the information recording/reproduction device 700 in Embodiments 1 and 2 described above may be implemented by hardware, software or a combination of hardware and software. A program for causing the information recording/reproduction device 700 to execute the recording/reproduction operations and the verification operation described above is stored on, for example, a built-in memory or the like in the drive control section 750. Such a computer program may be installed from a recording medium (optical disc, semiconductor memory, etc.) storing the program to the information recording/reproduction device 700, or may be downloaded via an electric communication line such as the Internet or the like.

### INDUSTRIAL APPLICABILITY

According to the present invention, when information such as management information is updated, verification is performed on the recorded management information and also on reused management information. Thus, even if data destruction or the like occurs at the time of recording due to unintentional track jump or the like, it can be guaranteed that the latest management information can be reproduced correctly. Owing to this, the reliability of data indispensable for recording or reproduction on or from an information recording medium or the like can be improved. The present invention is applicable to, for example, optical disc drive devices for performing recording or reproduction on or from an optical disc for which tracking control is made difficult due to the increase of density and the increase of the number of layers and to storage devices for enterprise such as file servers and archive server using an optical disc.

### REFERENCE SIGNS LIST

2 Track
3 Cluster
4 Inner zone
5 Data zone
6 Outer zone
10, 11, 12, 13 DMA
14 User data area
15 ISA
16 OSA
17 TDMA
20 File data area
21 First file management information area
22 Second file management information area
50 ADVP
51 VDS
52 LVD
53 FE (MDF)
60 Meta data file
61 FSD
62 FE (root directory)
63 FID (File A)
64 FE (File A)
70 File A data
100 Information recording medium
300 DMA
400 TDFL (DFL)
401 DEL header
402 Defect entry
404 Pre-replacement cluster position information
405 Post-replacement cluster position information
500 SRRI
501 SRRI header
502 SRR entry
504 SRR start position information
505 SRR final recording position information
600 TDDS (DDS)
601 DDS header
602 DFL position information
603 First TDFL position information
604 Second TDFL position information
605 Third TDFL position information
606 Fourth TDFL position information
607 SRRI position information
700 Information recording/reproduction device
710 Higher-level control device
720 Command processing section
730 Recording/reproduction section
740 Buffer
750 Drive control section
751 Management information acquisition section
752 Management information update section
753 Verification section
754 Management information recording section
755 Management information checking section
760 I/O bus

1. A recording/reproduction device, comprising:
a recording/reproduction section for recording or reproducing data on or from an information recording medium;
a verification section for reproducing the data recorded on the information recording medium by use of the recording/reproduction section and checking whether or not the data can be reproduced normally;
a management information recording section for recording, on the information recording medium by use of the recording/reproduction section, only management information which needs to be changed among a plurality of types of management information for managing the data recorded on the information recording medium; and
a management information checking section for checking, by use of the verification section, whether or not latest management information including management information which does not need to be changed and is to be reused can be reproduced normally.

2. The recording/reproduction device of claim 1, wherein in the case where the latest management information is recorded on the information recording medium discontinuously and management information different from the latest management information is recorded between positions at which the latest management information is recorded, the management information checking section does not reproduce the management information different from the latest management information during an operation of checking the latest management information.

3. The recording/reproduction device of claim 1, wherein in the case where the management information checking section confirms that the latest management information cannot be reproduced normally, the management information recording section re-records at least the management information which is not reproduced normally among the latest management information.

4. The recording/reproduction device of claim 1, wherein:
at least one of the plurality of types of management information includes management information position information which indicates a position at which the other types of management information are recorded; and
the management information checking section specifies a position at which the management information to be reused is recorded, based on the management information position information.

5. The recording/reproduction device of claim 1, wherein:
the plurality of types of management information are defect management information for managing a defective area of the information recording medium, recording management information indicating a recording state of the information recording medium, and a disc definition structure indicating a structure of the information recording medium;
the disc definition structure includes defect management information position information indicating a position at which the defect management information is recorded, and recording management information position information indicating a position at which the recording management information is recorded; and
the management information checking section specifies a position at which the management information to be reused is recorded, based on the defect management information position information and the recording management information position information.

6. The recording/reproduction device of claim 1, wherein:
in the case where recording of the management information which needs to be changed is successful with a retry, the management information checking section checks whether or not the latest management information including the management information to be reused can be reproduced normally; and
in the case where recording of the management information which needs to be changed is successful with no retry, the management information checking section checks whether or not the recorded management information which needed to be changed can be reproduced normally, but does not check whether or not the management information to be reused can be reproduced normally.

7. The recording/reproduction device of claim 1, wherein the management information checking section sets, as a checking target, only the latest management information recorded at a radial position within a prescribed range from a radial position at which the management information which needs to be changed is recorded.

8. A recording/reproduction method, comprising:
step (a) of recording data on an information recording medium;
step (b) of checking whether or not the data recorded on the information recording medium can be reproduced normally;
step (c) of recording, on the information recording medium, only management information which needs to be changed among a plurality of types of management information for managing the data recorded on the information recording medium; and
step (d) of checking whether or not latest management information including management information which does not need to be changed and is to be reused can be reproduced normally.

9. The recording/reproduction method of claim 8, wherein in the case where the latest management information is recorded on the information recording medium discontinuously and management information different from the latest management information is recorded between positions at which the latest management information is recorded, the management information different from the latest management information is not reproduced in step (d).

10. The recording/reproduction method of claim 8, wherein in the case where it is confirmed that the latest management information cannot be reproduced normally, at least the management information which is not reproduced normally among the latest management information is re-recorded.

11. The recording/reproduction method of claim 8, wherein:
at least one of the plurality of types of management information includes management information position information which indicates a position at which the other types of management information are recorded; and
in step (d), a position at which the management information to be reused is recorded is specified based on the management information position information.

12. The recording/reproduction method of claim 8, wherein:
the plurality of types of management information are defect management information for managing a defective area of the information recording medium, recording management information indicating a recording state of the information recording medium, and a disc definition structure indicating a structure of the information recording medium;
the disc definition structure includes defect management information position information indicating a position at which the defect management information is recorded, and recording management information position information indicating a position at which the recording management information is recorded; and
in step (d), a position at which the management information to be reused is recorded is specified based on the defect management information position information and the recording management information position information.

13. The recording/reproduction method of claim 8, wherein:
in the case where recording of the management information which needs to be changed is successful with a retry, step (d) is executed; and
the recording/reproduction method further comprises step (e) of, in the case where recording of the management information which needs to be changed is successful with no retry, checking whether or not the management information which needed to be changed, which is a part of the latest management information, can be reproduced normally.

14. The recording/reproduction method of claim 8, wherein in step (d), only the latest management information, recorded at a radial position within a prescribed range from a radial position at which the management information which needs to be changed is recorded, is set as a checking target.

15. A program for causing a recording/reproduction device to record or reproduce data on or from an information recording medium, the program causing the recording/reproduction device to execute:
step (a) of recording data on an information recording medium;
step (b) of checking whether or not the data recorded on the information recording medium can be reproduced normally;
step (c) of recording, on the information recording medium, only management information which needs to be changed among a plurality of types of management information for managing the data recorded on the information recording medium; and
step (d) of checking whether or not latest management information including management information which does not need to be changed and is to be reused can be reproduced normally.
